(19) United States
(12) Patent Application Publication
(10) Pub. No.: US 2017/0205531 A1
(43) Pub. Date: Jul. 20, 2017

(54) GEOLOGICAL MODELING WORKFLOW

(71) Applicant: Schlumberger Technology Corporation, Sugar Land, TX (US)

(72) Inventors: Thomas Berard, Cambridge, MA (US); Yu Yang, Canonsburg, PA (US); Jean Desroches, La Defense (FR)

(21) Appl. No.: 15/306,687

(22) PCT Filed: Apr. 30, 2015
(86) PCT No.: PCT/US2015/028536

§ 371 Date: Oct. 25, 2016

Related U.S. Application Data
(60) Provisional application No. 61/986,418, filed on Apr. 30, 2014.

(51) Int. Cl. G01V 11/00; E21B 47/00; E21B 7/04; E21B 43/25; E21B 49/00

(52) U.S. Cl. CPC G01V 11/00; E21B 43/25; E21B 49/00; E21B 49/003; E21B 7/04; E21B 47/0002

(57) ABSTRACT

A method can include receiving a geomechanical model associated with a geologic environment that includes a borehole where the geomechanical model includes a vertical dimension and lateral dimensions and where the borehole includes a lateral extent that spans a lateral distance in the geologic environment; conditioning the geomechanical model to provide a conditioned geomechanical model that includes representations of structural features based at least in part on borehole-wall image data of at least a portion of the lateral extent of the borehole; and determining a stress field for at least a portion of the geologic environment using the conditioned geomechanical model. The step of conditioning the geomechanical model can optionally include conditioning the geomechanical model to provide a conditioned geomechanical model that comprises representations of structural features based at least in part on sub-surface tool data of a substantially lateral extent of the geologic environment.

### RELATED APPLICATIONS

This application claims priority to and the benefit of a U.S. Provisional Application Ser. No. 61/986,418, filed 30 Apr. 2014, which is incorporated by reference herein.

### BACKGROUND

Phenomena associated with a geologic environment (e.g., a subsurface region, whether below a ground surface, water surface, etc.) may be modeled using various equations (e.g., stress, fluid flow, thermal, phase, etc.). As an example, a numerical model of a geologic environment may find use for understanding various processes related to exploration and production of natural resources (e.g., assessing depositional history, estimating reserves in place, drilling wells, forecasting production, etc.).

### SUMMARY

In accordance with some embodiments, a method includes receiving a geomechanical model associated with a geologic environment that includes a borehole where the geomechanical model includes a vertical dimension and lateral dimensions and where the borehole includes a lateral extent that spans a lateral distance in the geologic environment; conditioning the geomechanical model to provide a conditioned geomechanical model that includes representations of structural features based at least in part on borehole-wall image data of at least a portion of the lateral extent of the borehole; and determining a stress field for at least a portion of the geologic environment using the conditioned geomechanical model.

In some embodiments, an aspect of a method includes determining a stress field at least in part by setting at least one boundary condition and, for example, after determining the stress field, updating at least one of the at least one boundary condition.

In some embodiments, an aspect of a method includes determining at least one stimulation treatment parameter based at least in part on a stress field where, for example, the at least one stimulation treatment parameter corresponds to a stimulation treatment associated with a borehole and where an aspect of the method includes, for example, performing the stimulation treatment, at least in part by delivering fluid to the borehole.

In some embodiments, an aspect of a method includes acquiring borehole-wall image data via a tool positioned in a borehole.

In some embodiments, an aspect of a method includes identifying at least one structural feature as a dipping plane.

In some embodiments, an aspect of a method includes conditioning a geomechanical model by embedding representations of structural features based at least in part on seismic data.

In some embodiments, an aspect of a method includes a geologic environment that includes a borehole and an additional borehole where conditioning a geomechanical model includes embedding representations of structural features based at least in part on borehole-wall image data of at least a portion of the borehole and borehole-wall image data of at least a portion of the additional borehole.

In some embodiments, an aspect of a method includes representing structural features that include at least one fault.

In some embodiments, an aspect of a method includes representing structural features that include at least one discrete fracture network (DFN).

In some embodiments, an aspect of a method includes receiving a geomechanical model that includes a finite element model associated with a numerical solver that implements the finite element method.

In some embodiments, an aspect of a method includes performing a stimulation treatment that is based at least in part on a stress field and acquiring seismic energy data during the stimulation treatment where such a method can include updating at least one boundary condition of a conditioned geomechanical model based at least in part on the seismic energy data acquired during the stimulation treatment and determining an updated stress field for at least a portion of a geologic environment.

In accordance with some embodiments, a system is provided that includes a processor; memory operatively coupled to the processor; and one or more modules that include processor-executable instructions stored in the memory to instruct the system to receive a geomechanical model associated with a geologic environment that includes a borehole where the geomechanical model includes a vertical dimension and lateral dimensions and where the borehole includes a lateral extent that spans a lateral distance in the geologic environment; condition the geomechanical model to provide a conditioned geomechanical model that includes representations of structural features that are based at least in part on borehole-wall image data of at least a portion of the lateral extent of the borehole; and determine a stress field for at least a portion of the geologic environment using the finite element model.

In some embodiments, an aspect of a system includes a geomechanical model that includes a finite element model.

In some embodiments, an aspect of a system includes processor-executable instructions stored in the memory to instruct the system to implement a numerical solver that applies the finite element method.

In accordance with some embodiments, one or more non-transitory computer-readable storage media are provided that include computer-executable instructions to instruct a computer to: receive a geomechanical model associated with a geologic environment that includes a borehole where the geomechanical model includes a vertical dimension and lateral dimensions and where the borehole includes a lateral extent that spans a lateral distance in the geologic environment; condition the geomechanical model to provide a conditioned geomechanical model that includes representations of structural features that are based at least in part on borehole-wall image data of at least a portion of the lateral extent of the borehole; and determine a stress field for at least a portion of the geologic environment using the finite element model.

In some embodiments, an aspect of a non-transitory computer-readable storage medium includes instructions to implement a numerical solver that applies the finite element method.

In accordance with some embodiments, a method includes receiving a geomechanical model associated with a geologic environment where the geomechanical model includes lateral dimensions; conditioning the geomechanical model to provide a conditioned geomechanical model that includes representations of structural features based at least in part on sub-surface tool data of a substantially lateral extent of the geologic environment; and determining a stress field for at least a portion of the geologic environment using the conditioned geomechanical model.

In some embodiments, an aspect of a method includes sub-surface tool data that includes image data.

In some embodiments, an aspect of a method includes analyzing at least a portion of sub-surface tool data to identify a location of a fault and extrapolating the fault away from the location where, for example, extrapolating includes extrapolating the fault laterally away from a representation of a bore in the geomechanical model.

In some embodiments, an aspect of a method includes receiving a geomechanical model associated with a geologic environment that includes a bore and conditioning the geomechanical model based at least in part on sub-surface tool data acquired via a sub-surface tool disposed in the bore where, for example, the bore may be a borehole or a well.

In some embodiments, an aspect of a method includes acquiring additional sub-surface tool data and determining a stress field for at least a portion of a geologic environment based at least in part on at least a portion of the additional sub-surface tool data.

In some embodiments, an aspect of a method includes acquiring sub-surface tool data while drilling substantially laterally in a geologic environment.

In some embodiments, an aspect of a method includes adjusting drilling based at least in part on a stress field.

In accordance with some embodiments, a system is provided that includes a processor; memory operatively coupled to the processor; and one or more modules that include processor-executable instructions stored in the memory to instruct the system to receive a geomechanical model associated with a geologic environment where the geomechanical model includes lateral dimensions; condition the geomechanical model to provide a conditioned geomechanical model that includes representations of structural features based at least in part on sub-surface tool data of a substantially lateral extent of the geologic environment; and determine a stress field for at least a portion of the geologic environment using the conditioned geomechanical model.

In some embodiments, an aspect of a system includes an interface that receives sub-surface tool data while drilling substantially laterally in a geologic environment.

In some embodiments, an aspect of a system includes instructions to generate information to adjust drilling based at least in part on a stress field and, for example, an interface that transmits at least a portion of the information.

In accordance with some embodiments, one or more non-transitory computer-readable storage media are provided that include processor-executable instructions to instruct a computing system to: receive a geomechanical model associated with a geologic environment where the geomechanical model includes lateral dimensions; condition the geomechanical model to provide a conditioned geomechanical model that includes representations of structural features based at least in part on sub-surface tool data of a substantially lateral extent of the geologic environment; and determine a stress field for at least a portion of the geologic environment using the conditioned geomechanical model.

In some embodiments, an aspect of a non-transitory computer-readable storage medium includes processor-executable instructions to instruct a computing system to generate information to adjust a drilling operation based at least in part on a stress field.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a borehole tool, an example of a convention and an example of a system;

FIG. 3 illustrates an example of a technique that may acquire data;

FIG. 4 illustrates an example of a system;

FIG. 5 illustrates an example of a workflow;

FIG. 6 illustrates an example of a geologic environment and various examples of types of folds;

FIG. 7 illustrates examples of scenarios and an example of data;

FIG. 8 illustrates an example of data;

FIG. 9 illustrates an example of data;

FIG. 10 illustrates an example of a scenario and examples of data;

FIG. 11 illustrates an example of an environment and examples of data;

FIG. 12 illustrates an example of a method;

FIG. 13 illustrates an example of a model of a structural setting that includes faults;

FIG. 14 illustrates an example of a discrete fracture network model;

FIG. 15 illustrates an example of least compressive principal stress magnitude;

FIG. 16 illustrates a perspective view of an example of a model of a geologic environment that includes wells and associated information;

FIG. 17 illustrates a perspective view of the model of FIG. 16 and associated information;

FIG. 18 illustrates a plan view of the model of FIG. 17 and associated information;

FIG. 19 illustrates a perspective view of the model of FIG. 16 and associated information;

FIG. 20 illustrates a perspective view of a model and associated information;

FIG. 21 illustrates an example of a method and an example of a scenario;

FIG. 22 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

Sedimentary basins can be modeled using numerical techniques such as, for example, the finite element method. Such basins can include one or more faults. Various issues may arise when modeling basin faults. For example, finite elements may not be properly oriented with respect to a fault. Where petroleum systems modeling is desired to model migration of fluid near or at a fault, improper orientation of finite elements can give rise to inaccuracies.

Basin and petroleum systems modeling may assess generation, migration, and accumulation of hydrocarbons. Quantities such as pore pressure, geomechanical stresses and strains, temperature, and fluid potentials can assist understanding of a sedimentary basin and provide for an estimation of hydrocarbon generation, migration, and accumulation. These quantities may be described via formulations of equations that include PDEs. A spatial distribution and evolution through geological time of such processes may be a goal of basin modeling.

As analytical solutions seldom exist for PDEs, numerical simulation may be employed using a computing device, a computing system, etc. Various numerical techniques may include discretization of a space to form a model. For example, a finite element model may include many finite elements (e.g., a few million elements) where each element has an associated set of properties, for example, lithology (e.g., type of the material), porosity, temperatures, pore pressure, etc. Alignment of a grid for finite elements with geological features such as layer horizons and faults can help to provide an accurate and efficient simulation.

In an example embodiment, a method can create a grid that is suitably aligned with one or more geological features while allowing an efficient implementation and simulation on a computing device or computing system. Such a method can include providing a basic grid construction so that it is suitably aligned with global features of a model (e.g., layer horizons for a basin) followed by improving the description of local features (e.g., faults), optionally by locally altering the grid. For example, in a modeling process for a basin, layer horizons may be considered to construct a grid for finite elements. After consideration of the layer horizons, faults may be projected on surfaces (e.g., boundaries). In such an example, where finite elements have been locally refined, representation of a fault tends to be more accurate.

As an example, refinement may include splitting of one or more finite elements (e.g., to define smaller finite elements). Additionally, or alternatively, finite element node movement may occur. For example, local movement of one or more nodes may occur to improve representation of a fault. As an example, such movement may be conditioned to ensure that shifting of a node does not misalign geometry of a horizon. Further, a condition may be imposed such that a shift may be restricted to be smaller than the size of a finite element, for example, to avoid global topology changes to a grid by movement of a node or nodes.

The finite element method can include mapping (e.g., spatial transformations), for example, where a finite element is mapped from a physical space to a unit space to facilitate integration. Such an approach can allow for various finite element shapes in the physical space (or physical domain being modeled). In contrast, other techniques for spatial modeling such as finite difference or finite volume methods can exhibit numerical problems when considering deformed grids. In certain cases, these numerical problems may be severe. While mapping or transforms may be applied to these other techniques, they might not be inherent to these other techniques and may act to increase computational demands.

In an example embodiment, a method to more accurately represent a fault, a fracture or other geologic feature in a finite element model can be incorporated into an existing simulator program. In such an example, basic topology as well as the general geometry of a grid may be preserved, which may allow for usage of many types of analysis techniques in addition to finite element analysis.

For a finite element, material properties (e.g., rock or other material) may be uniformly defined. A grid for the finite elements (e.g., to define node positions for finite elements) can be aligned to geological features to describe geological volumes. A model may represent geological volumes in one or more dimensions in space (e.g., 1D, 2D or 3D). For example, for a 2D model, two-dimensional finite elements may represent volumes that interact with neighboring two-dimensional finite elements (e.g., for rectangular elements, an interior element may have four neighbors with shared boundaries and four additional neighbors with a shared node). For a 3D model, an interior cuboid element can have six neighbors with shared surfaces and up to an additional twenty four neighbors with a shared node (e.g., eight nodes with three additional neighbors per node, noting that the number can differ for collapsed surfaces, etc.). While boundary conditions may be limited to the six shared surfaces, where a node is shifted, the finite elements that share the shifted node may be affected. In an example embodiment, a method can operate on a 2D spatial finite element model or a 3D spatial finite element model. Further, an additional temporal dimension may make such models 3D and 4D overall.

Various issues exist for modeling and simulation of hydrocarbon generation amounts and trap sizes with captured hydrocarbons. In particular, model accuracy with respect to physical geometry of a geologic formation can impact accuracy as hydrocarbon migration pathways often follow small scale structures. Where mismatches exist between physical geometry and model geometry, inaccuracies related to migration may result. Such inaccuracies can impact exploration and appraisal of a basin and resources therein, for example, as to pressure prediction and well placement.

As mentioned, information about a geologic environment may aid in building of a model. Where a geologic environment includes one or more boreholes, a borehole tool may be employed to acquire subsurface data, which may aid locating and mapping of boundaries (e.g., bed boundaries) between layers of material, such as rock beds, and, for example, to visualize and orient fractures and faults.

A borehole tool may be configured to acquire electrical borehole images. As an example, the fullbore Formation MicroImager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole tool may be conveyed by a drilling assembly and/or by a cable to a sub-surface location (e.g., as a sub-surface tool). As an example, a borehole tool may be wireline tool and/or a logging while drilling (LWD) tool (e.g., or measurement while drilling (MWD)). As an example, data may include one or more of, for example, resistivity, density and acoustic measurement data. As an example, data may be transmitted from a tool, equipment associated with a tool, etc. to one or more devices, systems, etc. As an example, a simulation system may include one or more processors, memory, a network interface and processor executable instructions that can simulate one or more phenomena based at least in part on data acquired via a borehole tool. As an example, data may be transmitted in real time and therefore be made available for processing and interpretation, optionally at a location other than a wellsite (e.g., a field site). As an example, data may pertain to one or more features in a geologic environment (e.g., horizons, dips, faults, fractures, geobodies, etc.). As an example, a tool may acquire one or more types of information (e.g., RAB, Az GR or density, seismic acquired at or near a drill bit, etc.).

Raw data can include multiple electrode readings, caliper readings from individual pads or pairs of pads, and x-, y-, and z-axis accelerometer and magnetometer readings. Borehole deviation and a first pad (e.g., pad 1 for the tool) orientation can be determined from magnetometers. A sample rate for electrode and accelerometer data can be on the order of about 120 samples/ft (400 samples/m).

Areal coverage of a borehole face can be a function of width of electrode arrays, number of pads, borehole diameter, etc. As an example, about 40 percent to about 80 percent of a borehole face may be imaged. Where data is not collected, so-called “non-imaged parts”, raw data may be separated by blank “strips” (e.g., between adjacent pads on a resulting borehole log).

Processing of current data sensed remotely in response to delivery of current in a borehole can provide a map of resistivity of a rock-fluid system at the borehole face (e.g., cylindrical borehole surface). For viewing borehole data, a line may be defined along a “true north” direction along which the “cylindrical” data is “split” between top and bottom and unrolled to provide a 2-D view. The line along which the “cylinder” is “split” may be any other geographical direction or may be the “Top of hole” or other such orientation.

For a boundary, if planar and at a non-orthogonal angle to the axis of the cylinder, the intersection between the boundary and a cylindrical borehole is an ellipse. Upon unrolling the cylindrical image of the borehole surface image, this oval is “cut” and open up as one cycle of a sinusoidal curve. Because the sinusoidal curve is part of an oriented image, it corresponds to an orientation, and the lowermost part of the curve indicates the apparent dip (slope) azimuth (direction). The amplitude of the sinusoidal curve corresponds to a dip angle relative to the borehole, for example, where the greater the amplitude, the greater the dip angle relative to the borehole. On the other hand, in an extreme case, where the amplitude becomes zero, (i.e., a plane that is precisely perpendicular to the axis of a cylinder), the plane would appear as a straight line in an unrolled 2-D view.

Processing can include creating a series of borehole images where color maps are applied to different bins or ranges of resistivity values (e.g., for a tool that provides resistivity values). In the borehole image, color pixels can be arranged in their proper geometric position representing a borehole surface. One convention provides that low-resistivity features, such as shales or conductive minerals or conductive fluid-filled fractures or pore spaces, are displayed as dark colors; whereas, high-resistivity features, such as hydrocarbon-filled or well-cemented sandstones and limestones, are displayed as shades of yellow, and white—the higher the resistivity the brighter the image. As to a gray scale convention, black may correspond to low resistivity and white to high resistivity.

Processed borehole images may be of a static type or a dynamic type. Static images are those which have had one contrast setting applied to the entire borehole, which can provide useful views of relative changes in material resistivity. Dynamic images, which have had variable contrast applied in a moving window, can provide enhanced views of features such as vugs, fractures, and bed boundaries. Dynamic images tend to be better at bringing out subtle features in rocks that have very low resistivities, such as shales, and very high resistivities, such as carbonates and crystalline rocks or in any rocks with low relative contrast between the beds and other features.

As an example, a method may include providing borehole data organized with respect to a cylindrical surface, defining one or more bedding planes based at least in part on the borehole data, and transforming at least a portion of the borehole data to a planar slab format for a plane interior to the cylindrical surface. As an example, a system may include an interface to receive borehole data organized with respect to a cylindrical surface, a graphical user interface to align a sinusoidal graphic with respect to an image of the borehole data, circuitry to project at least a portion of the borehole data to a plane interior to the cylindrical surface and circuitry to render a 2-D image of the plane that includes bedding planes derived from alignment of the sinusoidal graphic and projected borehole data.

As an example, a method and/or a system may include one or more modules of the commercially available TECHLOG™ wellbore framework (Schlumberger, Houston, Tex.), which provides wellbore-centric, cross-domain workflows based on a data management layer. The TECHLOG™ wellbore framework includes features for petrophysics (core and log), geology, drilling, reservoir and production engineering, and geophysics.

As an example, a workflow may be performed during a drilling operation, a completion operation, a fracturing operation, etc. For example, consider a workflow that includes one or more simulations that can output information germane to a geologic environment being drilled, a bore being completed, a formation being fractured, etc. In such an example, the output information may pertain to one or more feature locations, one or more physical phenomena, etc. As an example, information output by a workflow may be used to adjust one or more field operations such as, for example, one or more drilling operations, one or more completion operations, one or more fracturing operations, etc. As an example, a loop may exist that includes one or more pieces of field equipment for operational control of surface and/or downhole equipment and that includes one or more computing systems that can simulate one or more physical aspects of a geologic environment being operated upon. In such an example, the loop may optionally provide for real-time control of the field equipment, the downhole equipment, etc. As an example, equipment may include surface and/or sub-surface equipment. As an example, a workflow may include performing borehole data processing and interpretation while a well is being drilled. Such a workflow may allow for the construction, iteratively or not, of one or more structural and/or geomechanical models as the well is being constructed.

As an example, seismic data about a geologic environment may aid in building of a model. As an example, seismic data may be acquired for a region in the form of traces. Acquisition equipment may be transported to a region for emitting energy from a source (e.g., a transmitter) and receiving reflected energy via one or more sensors (e.g., receivers) strung, for example, along an inline direction. Where a region includes layers, energy emitted by a transmitter of the acquisition equipment can reflect off the layers as well as one or more other structural features. Evidence of such reflections may be found in the acquired traces.

Seismic data may be acquired with reference to a surface grid (e.g., defined with respect to inline and crossline directions). For example, given grid blocks of about 40 meters by about 40 meters, a 40 km by 40 km field may include about one million traces. Such traces may be considered 3D seismic data where time approximates depth. As an example, a computer may include a network interface for accessing seismic data stored in one or more storage devices via a network. In turn, the computer may process the accessed seismic data via instructions, which may be in the form of one or more modules.

As an example, one or more attribute modules may be provided for processing seismic data. As an example, attributes may include geometrical attributes (e.g., dip angle, azimuth, continuity, seismic trace, etc.). Such attributes may be part of a structural attributes library. Structural attributes may assist with edge detection, local orientation and dip of seismic reflectors, continuity of seismic events (e.g., parallel to estimated bedding orientation), etc. As an example, an edge may be defined as a discontinuity in horizontal amplitude continuity within seismic data and correspond to a fault, a fracture, etc. Geometrical attributes may be spatial attributes and rely on multiple traces.

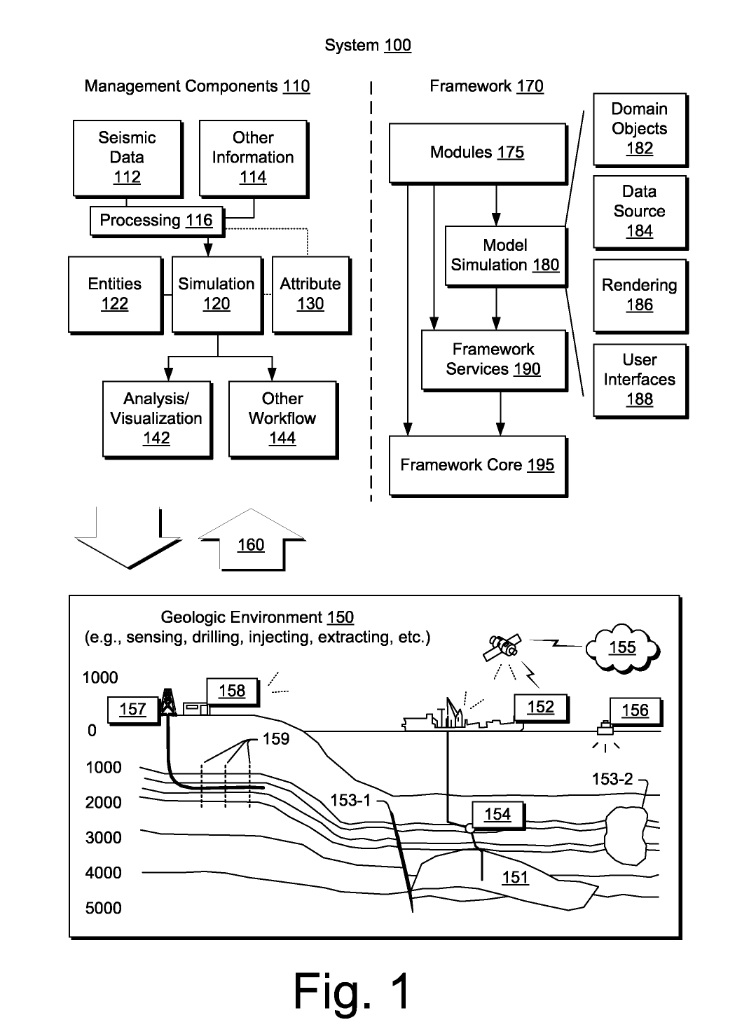

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT™ .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL™ seismic to simulation software framework (Schlumberger Limited, Houston, Tex.). The PETREL™ framework provides components that allow for optimization of exploration and development operations. The PETREL™ framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN™ framework environment (Schlumberger Limited, Houston, Tex.) allows for integration of add-ons (or plug-ins) into a PETREL™ framework workflow. The OCEAN™ framework environment leverages .NET™ tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN™ framework where the model simulation layer 180 is the commercially available PETREL™ model-centric software package that hosts OCEAN™ framework applications. In an example embodiment, the PETREL™ software may be considered a data-driven application. The PETREL™ software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as a fault 153-1, a geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via drilling and completing a well, fracturing, injecting, extracting, monitoring, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workflow may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL™ software, for example, that operates on seismic data, seismic attribute(s), etc. As an example, a workflow may be a process implementable in the OCEAN™ framework. As an example, a workflow may include one or more worksteps that access a module such as a plug-in (e.g., external executable code, etc.).

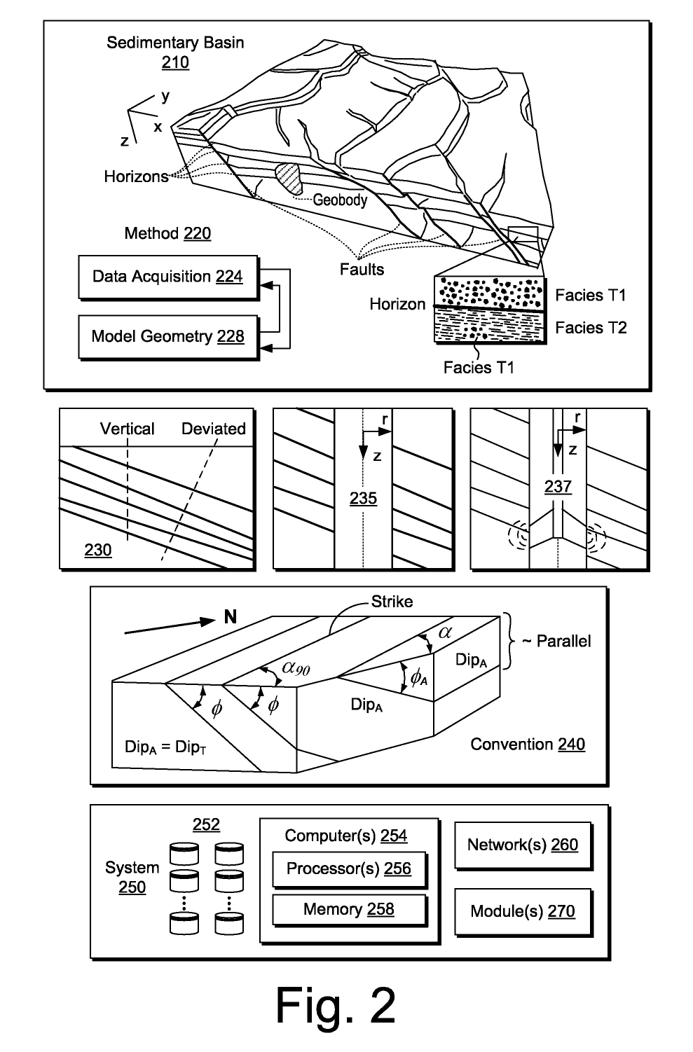

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD™ framework (Schlumberger Limited, Houston, Tex.) includes features for input of various types of information (e.g., seismic, well, geological, etc.) to model evolution of a sedimentary basin. The PETROMOD™ framework provides for petroleum systems modeling via input of various data such as seismic data, well data and other geological data, for example, to model evolution of a sedimentary basin. The PETROMOD™ framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL™ framework, workflows may be constructed to provide basin-to-prospect scale exploration solutions. Data exchange between frameworks can facilitate construction of models, analysis of data (e.g., PETROMOD™ framework data analyzed using PETREL™ framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore FORMATION MICROIMAGER™ (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviated and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG™ framework.

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles θ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation with respect to North (N) of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more modules 270 may include instructions (e.g., stored in memory) executable by one or more processors to instruct the system 250 to perform various actions. As an example, the system 250 may be configured such that the one or more modules 270 provide for establishing the framework 170 of FIG. 1 or a portion thereof. As an example, one or more methods, techniques, etc. may be performed using one or more modules, which may be, for example, one or more of the one or more modules 270 of FIG. 2.

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less that 1 Hz and/or optionally more than 100 Hz). Seismic data may be processed and interpreted, for example, to understand better composition, fluid content, extent and geometry of subsurface rocks.

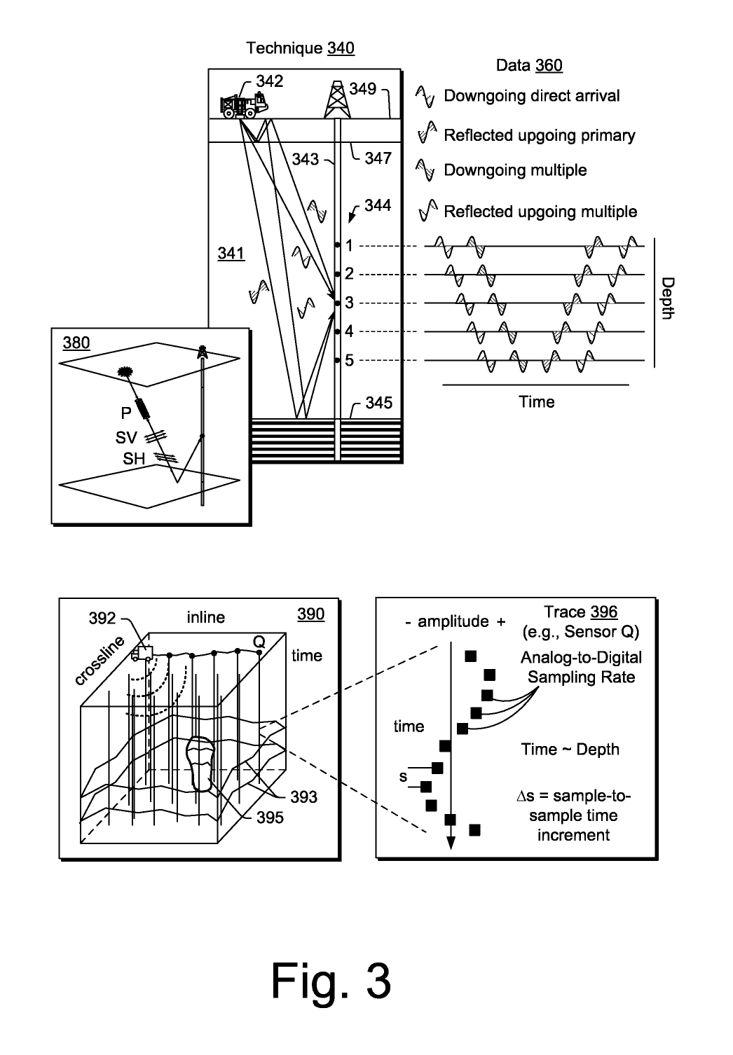

FIG. 3 shows an example of an acquisition technique 340 to acquire seismic data (see, e.g., data 360). As an example, a system may process data acquired by the technique 340, for example, to allow for direct or indirect management of sensing, drilling, injecting, extracting, etc., with respect to a geologic environment. In turn, further information about the geologic environment may become available as feedback (e.g., optionally as input to the system). As an example, an operation may pertain to a reservoir that exists in a geologic environment such as, for example, a reservoir. As an example, a technique may provide information (e.g., as an output) that may specifies one or more location coordinates of a feature in a geologic environment, one or more characteristics of a feature in a geologic environment, etc.

In FIG. 3, the technique 340 may be implemented with respect to a geologic environment 341. As shown, an energy source (e.g., a transmitter) 342 may emit energy where the energy travels as waves that interact with the geologic environment 341. As an example, the geologic environment 341 may include a bore 343 where one or more sensors (e.g., receivers) 344 may be positioned in the bore 343. As an example, energy emitted by the energy source 342 may interact with a layer (e.g., a structure, an interface, etc.) 345 in the geologic environment 341 such that a portion of the energy is reflected, which may then be sensed by one or more of the sensors 344. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 341 is shown as including a layer 347 that resides below a surface layer 349. Given such an environment and arrangement of the source 342 and the one or more sensors 344, energy may be sensed as being associated with particular types of waves.

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 3, the acquired data 360 can include data associated with downgoing direct arrival waves, reflected upgoing primary waves, downgoing multiple reflected waves and reflected upgoing multiple reflected waves. The acquired data 360 is also shown along a time axis and a depth axis. As indicated, in a manner dependent at least in part on characteristics of media in the geologic environment 341, waves travel at velocities over distances such that relationships may exist between time and space. Thus, time information, as associated with sensed energy, may allow for understanding spatial relations of layers, interfaces, structures, etc. in a geologic environment.

FIG. 3 also shows a diagram 380 that illustrates various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that may characterize anisotropy of media (e.g., seismic anisotropy), consider the Thomsen parameters ε, δ and γ. The Thomsen parameter δ describes depth mismatch between logs (e.g., actual depth) and seismic depth. As to the Thomsen parameter ε, it describes a difference between vertical and horizontal compressional waves (e.g., P or P-wave or quasi compressional wave qP or qP-wave). As to the Thomsen parameter γ, it describes a difference between horizontally polarized and vertically polarized shear waves (e.g., horizontal shear wave SH or SH-wave and vertical shear wave SV or SV-wave or quasi vertical shear wave qSV or qSV-wave). Thus, the Thomsen parameters ε αnd γ may be estimated from wave data while estimation of the Thomsen parameter δ may involve access to additional information.

In the example of FIG. 3, a diagram 390 shows acquisition equipment 392 emitting energy from a source (e.g., a transmitter) and receiving reflected energy via one or more sensors (e.g., receivers) strung along an inline direction. As the region includes layers 393 and, for example, the geobody 395, energy emitted by a transmitter of the acquisition equipment 392 can reflect off the layers 393 and the geobody 395. Evidence of such reflections may be found in the acquired traces. As to the portion of a trace 396, energy received may be discretized by an analog-to-digital converter that operates at a sampling rate. For example, the acquisition equipment 392 may convert energy signals sensed by sensor Q to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

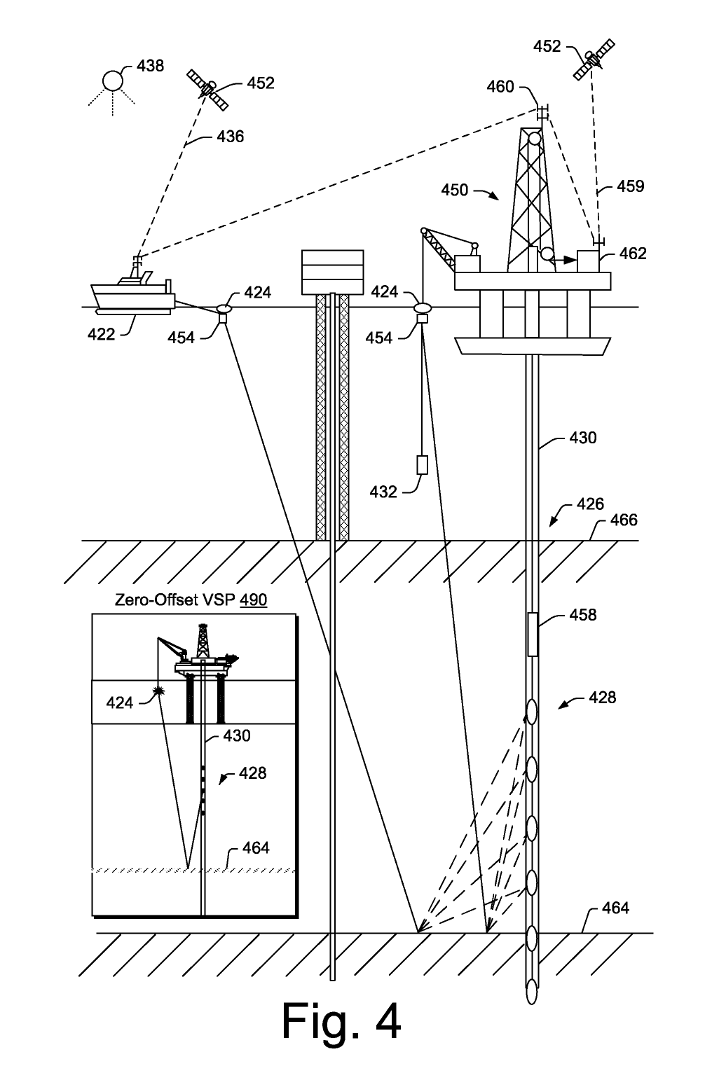

FIG. 4 shows an example of a system 420 in which one or more vessels 422 may be employed to enable seismic profiling, e.g., three-dimensional vertical seismic profiling (VSP) or rig/offset vertical seismic profiling (VSP). In the example of FIG. 4, the system 420 is illustrated as including a rig 450, the vessel 422, and one or more acoustic receivers 428 (e.g., a receiver array). As an example, a vessel may include a source 424 (e.g., or source array) and/or the rig 450 may include a source 424 (e.g., or source array).

As an example, the vessel 422 may travel a path or paths where locations may be recorded through the use of navigation system signals 436. As an example, such signals may be associated with a satellite-based system that includes one or more satellites 452 and 438. As an example, the satellite 438 may be part of a global positioning system (GPS), which may be implemented to record position, speed, direction, and other parameters of the vessel 422. As an example, one or more satellites, communication equipment, etc. may be configured to provide for VSAT communications, VHF communications, UHF communications, etc.

In the example of FIG. 4, the acoustic receivers 428 may be part of a data acquisition system 426, for example, that may be deployed in borehole 430 via one or more of a variety of delivery systems, such as wireline delivery systems, slickline delivery systems, and other suitable delivery systems. As an example, the acoustic receivers 428 may be communicatively coupled with processing equipment 458, which may be positioned at a downhole location. By way of example, processing equipment 458 may include a telemetry system for transmitting data from acoustic receivers 428 to additional processing equipment 462 located at the surface, e.g., on the rig 450 and/or vessels 422. As an example, information acquired may optionally be transmitted (see, e.g., signals 459).

Depending on the specifics of a given data communication system, examples of surface processing equipment 462 may include a radio repeater 460 and/or one or more of a variety of other and/or additional signal transfer components and signal processing components. The radio repeater 460 along with other components of processing equipment 462 may be used to communicate signals, e.g., UHF and/or VHF signals, between vessels (e.g., the vessel 422 and one or more other vessels) and the rig 450, for example, to enable further communication with downhole data acquisition system 426.

As an example, the acoustic receivers 428 may be coupled to the surface processing equipment 462 via one or more wire connections; noting that additionally or alternatively wireless and/or optical connections may be employed.

As an example, the surface processing equipment 462 may include a synchronization unit, for example, to assist with coordination of emissions from one or more sources (e.g., optionally dithered (delayed) source arrays). As an example, coordination may extend to one or more receivers (e.g., consider the acoustic receivers 428 located in borehole 430). As an example, a synchronization unit may use coordinated universal time, optionally employed in cooperation with a global positioning system (e.g., to obtain UTC data from GPS receivers of a GPS system).

FIG. 4 illustrates examples of equipment for performing seismic profiling that can employ simultaneous or near-simultaneous acquisition of seismic data. By way of example, the seismic profiling may include three-dimensional vertical seismic profiling (VSP) but other applications may utilize rig/offset vertical seismic profiling or seismic profiling employing walkaway lines. As an example, an offset source may be provided by the source 424 located on the rig 450, on the vessel 422, and/or on another vessel or structure (e.g., stationary and/or movable from one location to another location).

As an example, a system may employ one or more of various arrangements of a source or sources on a vessel(s) and/or a rig(s). As shown in the example of FIG. 4, the acoustic receivers 428 of downhole acquisition system 426 are configured to receive the source signals, at least some of which are reflected off a reflection boundary 464 located beneath a sea bottom 436. The acoustic receivers 428 may generate data streams that are relayed uphole to a suitable processing system, e.g., the processing system 462.

While the acoustic receivers 428 may generate data streams, a navigation system may determine a real-time speed, position, and direction of the vessel 422 and also estimate initial shot times accomplished via signal generators 454 of the appropriate source 424 (e.g., or source array). A source controller may be part of the surface processing equipment 462 (e.g., located on the rig 450, on the vessel 422, or at other suitable location) and may be configured with circuitry that can control firing of acoustic source generated signals so that the timing of an additional shot time (e.g., optionally a shot time via a slave vessel) may be based on an initial shot time (e.g., a shot time via a master vessel) plus a dither value.

As an example, a synchronization unit of, for example, the surface processing equipment 462, may coordinate firing of dithered acoustic signals with recording of acoustic signals by the downhole acquisition system 426. A processor system may be configured to separate a data stream of the initial shot and a data stream of the additional shot via a coherency filter. As an example, an approach may employ simultaneous acquisition and/or may not perform separation of the data streams. In such cases, the dither may be effectively zero.

After an initial shot time at T=0 (T0) is determined, subsequent firings of acoustic source arrays may be offset by a dither. The dithers may be positive or negative and sometimes created as pre-defined random delays. Use of dithers facilitates the separation of simultaneous or near-simultaneous data sets to simplify the data processing. The ability to have acoustic source arrays fire in simultaneous or near-simultaneous patterns reduces the overall amount of time used for three-dimensional vertical seismic profiling source acquisition. This, in turn, may reduce rig time. As a result, the overall cost of the seismic operation may be reduced, rendering the data intensive process much more accessible.

If acoustic source arrays used in the seismic data acquisition are widely separated, the difference in move-outs across the acoustic receiver array of the wave fields generated by the acoustic sources can be sufficient to obtain a relatively clean data image via processing the data. However, even when acoustic sources are substantially co-located in time, data acquired a method involving dithering of the firing times of the individual sources may be processed to a formation image. For example, consider taking advantage of the incoherence of the data generated by one acoustic source when seen in the reference time of another acoustic source.

Also shown in FIG. 4 is an inset example of a zero-offset vertical seismic profile (VSP) scenario 490. In such an example, an acquisition geometry may be limited to an ability to position equipment that is physically coupled to the rig 450. As shown, for given the acquisition geometry, there may be no substantial offset between the source 424 and bore 430. In such an example, a zero-offset VSP may be acquired where seismic waves travel substantially vertically down to a reflector (e.g., the layer 464) and up to the receiver 428, which may be a receiver array. Where one or more vessels are employed (e.g., the vessel 422), one or more other types of surveys may be performed. As an example, a three-dimensional VSP may be performed using a vessel.

As to examples of numerical techniques, consider a finite difference technique, a finite element technique and a finite volume technique. A finite difference technique relies on finite difference equations. For example, a spatial derivative of a function f may be approximated by difference equations. If time is introduced, this can also be represented using finite difference equations, for example, consider expanding the one dimensional “grid” in another dimension, i.e., time. In such an example, points exist for the one dimensional “grid” for different times. Thus, a two-dimensional grid can be used for both spatial and temporal modeling where it is the point-to-point distances or times of the grid that define the difference equations.

As to a finite element technique (e.g., more generally a technique based on the finite element method), it can include subdomains (e.g., finite elements). For example, a domain may be divided into subdomains where each subdomain has an associated set of basis functions (e.g., shape functions). A subdomain and its basis functions may serve as a definition of a finite element. In the finite element method, nodes define the extent of a subdomain that may be represented by a set of basis functions (e.g., piecewise polynomial functions, etc.). Basis functions conceptually model the “interior” of a finite element (i.e., the interior of a subdomain). Another technique, the boundary element method, models boundaries.

As to the finite volume technique (or finite volume method), it relies on fluxes, for example, surface integrals of individual respective finite volumes with respect to “connected” finite volumes (i.e., an integral conservation law) to calculate fluxes (i.e., in and out of each finite volume).

As an example, a geomechanics simulator may be configured to perform simulations based at least in part on finite elements, for example, via a finite element technique (e.g., a finite element method (FEM)). As an example, consider a geomechanics simulator such as the commercially available VISAGE™ finite-element geomechanics simulator (Schlumberger Limited, Houston, Tex.). The VISAGE™ simulator can perform simulations that may assist with planning for and mitigating risks.

As an example, a geomechanics simulator may include modules for modeling compaction and subsidence; well drilling and completion integrity; cap-rock and fault-seal integrity; mechanically-driven reservoir behavior; thermal recovery; CO₂ disposal; etc.

As an example, a seismic-to-simulation framework such as the PETREL™ framework, optionally in combination with the OCEAN™ framework, may include features that facilitate data flows and that provide graphical user interfaces that support geomechanics simulation, configuration and results visualization.

As an example, a workflow may include receiving information in one or more of multiple data types, for example, to create multidimensional geomechanics property and stress models, or add geomechanics data to augment existing reservoir subsurface models. Integration of seismic-to-simulation workflows capabilities with geomechanics workflow capabilities may aid in geomechanics model development, for example, to generate a model (e.g., via integration with one or more of geophysics, geology, petrophysics, and reservoir data).

As an example, a workflow may include creating an initial structural and properties model, which may be input to a geomechanics numerical simulator. As an example, such a workflow may integrate PETREL™ framework and VISAGE™ geomechanics simulator functionalities, optionally in an OCEAN™ framework.

As an example, a geomechanics simulator may be operatively coupled to a reservoir simulator. For example, the VISAGE™ simulator may be operatively coupled to the ECLIPSE™ reservoir simulator (e.g., for one-way and two-way coupling). For example, in one-way coupling, the ECLIPSE™ simulator may model flow of fluids in a reservoir and calculate pressure, temperature, and saturation changes that result. In such an example, the VISAGE™ simulator may use calculated results of the ECLIPSE™ simulator to perform 3D static and/or 4D flow-, pressure-, and temperature-coupled calculations for rock stresses, deformations, and failure. As an example, two-way coupling between the ECLIPSE™ and VISAGE™ simulators may allow permeability updating of a reservoir model at one or more selected time-steps, as well as, for example, updating of mechanical properties in the geomechanics model to account for effects such as changing saturations and water softening.

As an example, where a model may be large (e.g., millions of elements), or coupled to reservoir simulation, a computing system may be configured to perform parallel geomechanics simulation runs, for example, using local or remote clusters. As an example, a process (e.g., for single machines and/or multicore clusters) may be managed by a framework that can permit seamless workflows.

A geomechanics simulator may include one or more modules that can model faults, fractures, etc. As an example, one or more modules may provide for handling of highly heterogeneous models (e.g., where high-degree complexity that exists in a geological model may be maintained throughout a geomechanics analyses).

As an example, a geomechanics simulator may include one or more modules for 3D and 4D geomechanics simulation, for example, across one or more portions of a field's lifecycle. Such capabilities may allow geoscientists and engineers to assess and mitigate potential geomechanics problems affecting well and completions, stimulation, production, injection, and field management.

As an example, a workflow may include simulating fractures. As an example, consider simulating complex fractures in shale reservoirs. As mentioned, fractures may be generated artificially, for example, via hydraulic fracturing. Hydraulic fracturing may be considered a stimulation treatment that may aim to enhance recovery of one or more resources from a reservoir or reservoirs.

As an example, a framework may include one or more modules that can model stimulation of a geologic environment, for example, to generate one or more fractures. For example, consider the commercially available MANGROVE™ engineered stimulation design package that may be operated in conjunction with a framework such as, for example, the PETREL™ framework (e.g., optionally in the OCEAN™ framework). The MANGROVE™ package may be operated as a hydraulic fracturing simulator and may be, for example, integrated into one or more seismic-to-simulation workflows (e.g., for conventional and/or unconventional reservoirs). As an example, the MANGROVE™ package may be implemented to grid and model complex fractures, which may be used for reservoir simulation.

As an example, stimulation design functionality may be implemented to predict realistic fracture scenarios. For example, consider functionality that can provide for simulation of nonplanar hydraulic fractures using a unconventional fracture model (UFM) and/or wiremesh model.

Stimulation design may integrate one or more of geological and geophysical (G&G), petrophysical, geomechanical, and microseismic data. Stimulation modeling may help to increase productivity and, for example, reduce use of fracturing materials (e.g., fluid, proppant, etc.).

As an example, a stimulation design package may be implemented as a part of a workflow that aims to optimize well completion designs. As a poorly completed well is not likely to produce at maximum potential, an engineered process based on reservoir characterization may provide better completion designs. Whether input is G&G data via 3D models, well logs, offset wells, or pilot wells, completion and stimulation designs may be customizable to increase ROI by producing the reservoir more effectively.

A stimulation design workflow may provide estimates of proppant placement, fracture network dimensions, and reservoir penetration based on formation properties such as, for example, one or more of reservoir fluid rheology, leakoff coefficient, permeability, and closure stress.

As an example, a feedback loop may be implemented to compare simulations to actual results. For example, real-time data, such as that acquired by a hydraulic fracture mapping service (e.g., consider STIMMAP™ as a stimulation mapping service) may be compared to simulated results (e.g., to help to optimize treatments as they are being performed). Such comparisons may help improve well planning and reduce operational risks.

As an example, a workflow may include simulating wellbore stability conditions for drilling applications. Stability conditions may include, for example, one or more of mechanical stability and/or chemical stability conditions along a given well trajectory. As an example, stability conditions may concern rock, natural fractures and faults penetrated by a well, or bedding surfaces penetrated by a well.

As an example, a workflow may include analyzing sensitivity of one or more stability conditions, for example, with respect to well location and orientation, with respect to pressure of drilling mud, and/or with respect to chemical composition of drilling mud. An analysis may include derivation of a drilling mud density threshold and/or, for example, one or more mud composition thresholds relative to various failure mechanisms. As an example, an analysis may provide a definition of a safe mud density and/or, for example, a composition window bounded by one or several thresholds. As an example, an analysis may provide a definition of a most stable well orientation and/or trajectory.

As an example, a simulation may include a calibration step whereby conditions forecast by a model are compared with observations and/or measurements made in one or more existing wells, for example, where discrepancy is evaluated. As an example, one or more model parameters and/or simulation parameters may be adjusted to reduce a discrepancy. As an example, a workflow may include one or more feedback loops, for example, between observations and/or measurements and an application, a geomechanical model, a structural model, etc.

As an example, a simulation or simulations may be performed prior to one or more drilling operations, for example, for planning and design purposes. As an example, a simulation or simulations may be undertaken during drilling. As an example, a simulation may be updated while drilling or after drilling, using a feedback loop to capture in the simulation information gained during drilling and/or by drilling. As an example, a well plan, a well being drilled, etc., may be revised based at least in part on simulation results. For example, consider revising a well's trajectory based at least in part on simulation results where the simulation results are based at least in part on information acquired during a drilling operation.

As an example, a workflow may include simulating integrity of one or more wells, for example, during extraction and/or injection of fluid. As an example, a simulation may include analyzing stability of various elements of one or more wells and of surroundings thereof, for example, as mechanical, chemical, and thermal conditions are changing around a well or wells due to extraction from, and/or injection of fluid into a reservoir.

As an example, stability may be investigated from a mechanical deformation and failure point of view and/or from a chemical alteration point of view. As an example, a deformation analysis may include modeling of elasto-plastic or creep material behavior. As an example, one or more well elements may include casings, casing centralizers, cement, packers, or valves. As an example, stability of one or more geological features may be analyzed, such as, for example, one or more of bedding surfaces, faults, or natural fractures intersected by a well or wells.

As an example, behavior of one or more salt formations at or proximate to a well or wells may be analyzed, for example, including in its capacity to transmit stress over time to one or more well elements. As an example, a simulation or simulations may include parametric or sensitivity analyses to select well elements and assemblies that can sustain expected changes and therefore help ensure well completion integrity during subsurface exploration, exploitation, etc. As an example, a simulation may include a calibration process whereby conditions forecast by a model are compared with observations and/or measurements made in one or more existing wells and discrepancy evaluated. In such an example, one or more model parameters and/or simulation parameters may be adjusted to reduce a discrepancy. As an example, a simulation may be updated while fluids are injected and/or produced, for example, using a feedback loop to compare simulation results with the measurements and/or observations taken during one or more operations. As an example, a completion plan, a completion, etc., of a well may be revised based at least in part on simulation results, which may become available during a drilling operation, a completion operation, etc. For example, consider a method that includes changing casing hardware or cement based at least in part on simulation results where the simulation results are based at least in part on information acquired during a drilling operation, a completion operation, etc.

As an example, a workflow may include simulating the propensity of rocks at or proximate to one or more perforations and/or at or proximate to one or more hydraulic fractures with respect to risk of failure and/or risk of producing solid particles. As an example, a simulation may include derivation of one or more production or injection thresholds with respect to onset of one or more of such failure mechanisms. As an example, a threshold may be a flow rate threshold, a pressure threshold, etc., where one or more of such thresholds may be time-dependent.

As an example, a simulation may include a calibration process whereby one or more conditions forecast by a model are compared with observations and/or measurements made in one or more existing wells where the calibration process aims to reduce one or more discrepancies and/or evaluate one or more discrepancies. As an example, one or more model parameters and/or simulation parameters may be adjusted to reduce a discrepancy. As an example, a simulation may include parametric or sensitivity analyses, for example, to define production schedules, in terms of rates or pressures (e.g., in an effort to avoid solids production, etc.). As an example, a simulation may provide guidance as to one or more particular mechanism, such as sand screens or of gravel packs, to complete or produce one or more wells to mitigate impact of produced solids on well integrity (e.g., or ancillary equipment). As an example, a simulation may be updated while fluids are produced, using a feedback loop to compare simulation results with measurements and/or observations taken during production. As an example, a production schedule may be revised based at least in part on simulation results that are based at least in part on information acquired during an operation (e.g., a field operation). For example, consider a workflow that includes revising a production schedule by changing flow pressure based at least in part on simulation results that account for information acquired during one or more field operations.

As an example, a workflow may include simulating several aspects of well construction operations, as well as, for example, several aspects of production from one or more wells (e.g., consider groups of wells). As an example, a simulation may include analyses of sensitivity to type of well, to number of wells, to locations and trajectories of one or more wells, etc. A simulation may include evaluating benefits or drawbacks according to various combinations of performance factors, for example, as a function of a field development plan. As an example, a simulation may be updated after one or more wells have been constructed and/or produced.

As an example, a workflow may implement one or more modules that can provide for geological interpretation of borehole images and dip data, for example, consider single-well and multi-well interpretation, structural modeling, and well placement services. As an example, consider the commercially available EXPANDBG™ package (Schlumberger Limited, Houston, Tex.), which may be implemented in conjunction with the PETREL™ framework. Such a package may help to extend high-resolution borehole data, such as images and dips, to reservoir scale. In a workflow, a resulting model may be used, for example, to improve drilling and reservoir development decisions. The EXPANDBG™ package can provide for near-wellbore to reservoir-scale modeling.

As an example, a package may include one or more modules that can be implemented in a workflow for generating high-definition structural models, for example, using dip data (e.g., with or without seismic inputs). As an example, 3D near-well structural models may be utilized to help explain structural controls near a well, for example, permitting more precise sidetracking and well placement decisions. Providing a 3D static model can enable operational decisions during well construction, which may lead to more efficient well building and better production.

A structural model may include multiple structures, multiple faults, and unconformable surfaces. Such 3D models may also benefit fields with complex subseismic-scale structural elements that may affect reservoir development and production.

A package such as the EXPANDBG™ package may include one or more modules for near-well to reservoir-scale structural modeling from dip logs, semi-automated input generation for discrete fracture network (DFN) modeling, multi-well paleocurrent and geobody geometry interpretation, stratigraphic correlation and isopach mapping, drilling polarity plotting, etc. As an example, semi-automated fracture extraction and interpretation may be implemented in a workflow to generate fracture logs and statistics tailored for DFN modeling. In such an example, fracture data may be used for near-well to reservoir-scale fracture modeling. A workflow may include one or more of dip picking and classification, sequence analysis, structural dip computation and removal, drilling polarity logging and stratigraphic, thickness index computation, structure delineation, fault stick creation, isopach map creation, and structural dip projection-surface.

A PETREL™ reservoir geomechanics package may be implemented, for example, as an integrated environment for multi-dimensional preproduction geomechanics modeling or for 4D geomechanics modeling of fields under operation. As an example, finite-element geomechanics simulation (e.g., via the VISAGE™ simulator) may be combined with one or more other interpretation and modeling workflows (e.g., within a PETREL™ framework).

As an example, a reservoir geomechanical model may include horizontal grid cell dimensions in a range of about 50 m to about 200 m. Such dimensions may be about an order of magnitude too coarse, at least horizontally, to provide beneficial information on a well sector scale (e.g., considering hydraulic fracture dimensions). Single dimensional (e.g., 1D) geomechanical models may include log-scale resolution along a bore (e.g., a well, etc.) where the information may be relatively constrained (e.g., as to certainty) to a region proximate to the bore and lacking or less reliable as an indicator of structure away from the bore (e.g., along a hydraulic fracture length). As an example, a workflow may be constructed that can integrate functionality that may be available in a number of applications, for example, to consume 3D geomechanical input for drilling and completion analyses at well sector scale. For example, consider an approach that may include implementation of a fracture design application such as the commercially available MANGROVE™ package, which may include one or more modules for unconventional fracture modeling (e.g., for hydraulic fracture design and evaluation).

As an example, a workflow may include filling a scale/resolution gap by enabling the construction of a 3D, structurally-involved, and high-enough resolution geomechanical model at the scale of a well sector and, as a by-product, by delivering a geomechanical solution superior to that of a 1D approach.

As an example, a workflow may be implemented using a system that includes technology associated with borehole-wall imaging, image data processing and interpretation for structural model building, and finite element-based geomechanical modeling.

As an example, a workflow may include worksteps that build on borehole-wall image data and geological interpretation to capture and render (e.g., for purposes of numerical modelling) the structural setting, faults and natural fractures, with relatively fine detail, in multiple dimensions (e.g., consider 3D). As an example, a workflow may integrate bore-based information into a finite element-based model for refining the finite element-based model, for example, in a region that may be of the order of a few hundreds of meters away from a bore. As an example, where multiple bores are present, such an approach can close informational gaps that may exist in a finite element-based model such as a reservoir geomechanical model. As an example, building a model, refining a model, etc. may provide for resolution of the model of the order of artificial fractures. For example, consider hydraulic fractures that may be of the order of hundreds of meters.

As an example, a model may be built and/or refined that includes a resolution laterally that is of the order of about one hundred meters (e.g., about 300 feet). As an example, a model may be built and/or refined that includes resolution in lateral directions (e.g., consider x and y directions in a Cartesian coordinate system) of the order of about one hundred meters. For example, consider a method that includes receiving a model that includes a vertical resolution that is finer than its lateral resolution. As an example, such a model may be suited to modeling an environment that is to include one or more vertical wells. In a scenario where an environment is to include one or more deviated wells (e.g., consider one or more lateral wells), the resolution of the model may be increased in one or more lateral directions. in such a scenario, where one or more lateral wells are to be used to perform fracturing, the lateral resolution of the model may enhance planning of a fracturing process, execution of one or more stages of a fracturing plan, etc.

As an example, the MANGROVE™ package may provide for generation of suitable resolution simulation grids by gridding a fracture networks while capturing fracture dimensions and conductivities, as well as tracking the propped and unpropped regions in the networks. As an example, unstructured and/or structured gridding tools, as appropriate, may be implemented to help capture geology and fracture stimulation impact.

As an example, one or more of a planar fracture model, a multilayer fracture model, a UFM and a wiremesh model may be implemented for simulating fractures such as, for example, nonplanar complex hydraulic fractures in shale reservoirs and/or “conventional” planar fractures.

As an example, a UFM may be coupled to numerical modeling framework, for example, for simulating complex fracture geometries, while accounting for reservoir heterogeneity, stress anisotropy, and stress-shadow effects. Such an approach may model hydraulic fracture interactions with natural fractures while solving for fracture propagation mechanics and proppant transport. As to a wiremesh model, it may include a mathematical representation of a hydraulic fracture network, which may, for example, provide for estimation of proppant placement and fracture network dimensions.

As an example, hydraulic fracture simulator models may model fracture growth into layers above and/or below a pay zone, for example, along with bi-wing fracture extension. As an example, the MULTIFRAC™ package (Schlumberger Limited, Houston Tex.) may provide for simultaneous multizone fracturing simulations (e.g., with simultaneous initiation and extension of multiple hydraulic fractures).

As an example, a workflow can include taking a resulting structural model as an input to a 3D finite element-based geomechanical model. Such an approach can enable a workflow that integrates single-well information and yet 3D, structurally-involved, high-resolution geomechanical modeling at a well sector scale. Such an approach may allow for relaxing a number of assumptions underlying a 1D approach to single-well geomechanical modeling. In such an example, a workflow may deliver an improved stress solution for input to analyses of well-centric processes such as hydraulic fracture design and evaluation. As an example, in a workflow scenario, while one or more points of entry for fracturing fluid may lie on a wellbore trajectory where information may be available (e.g., as acquired via logs, 1D computations, etc.), fractures emanating therefrom can extend some distance away from the wellbore. In such an example, as distance increases, the information may become less certain. Thus, the workflow scenario can include modeling that provides information in regions that may be some distance from a wellbore or wellbores (e.g., regions into which one or more fractures may extend).

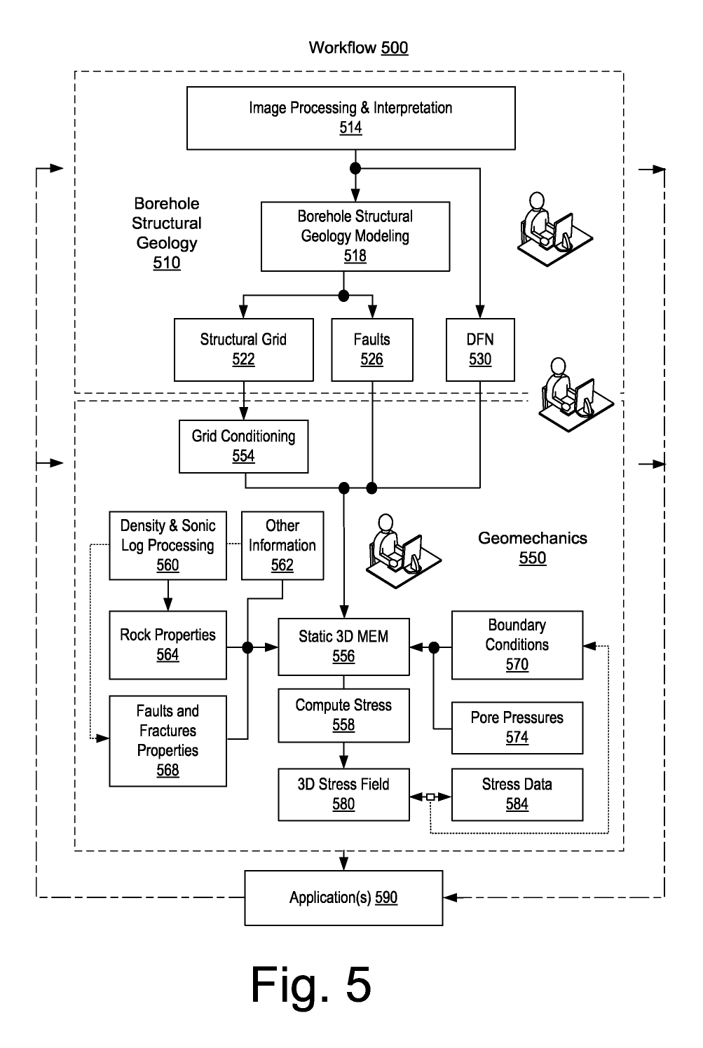

FIG. 5 shows an example of a workflow 500, which may be performed using one or more computing systems. As an example, one or more operators may interact with one or more computing systems such that input is received, which may be associated with instructions, commands, etc. As an example, input may be interpretation input, command input to execute instructions using a processor, etc.

As an example, the workflow 500 may provide for geomechanical modeling in three spatial dimensions at a scale of a well sector with resolution sufficient to model phenomena associated with, for example, hydraulic fractures. The workflow 500 may build on information from one or more bores such as, for example, borehole-wall image data and may also build on information from structural geology interpretation and modeling to capture and render a structural setting (e.g., including faults and natural fractures) with a level of detail in three spatial dimensions up to a distance of the order of about a hundred meters to several hundred meters from a bore or bores. As an example, the workflow 500 may include receiving borehole-wall image data. As an example, the workflow 500 may include receiving borehole-wall image data and other data such as seismic data.

As an example, the workflow 500 may include constructing a structural model in three spatial dimensions that can be a basis for a three-dimensional geomechanical earth model (3D MEM), which may, for example, be a finite element model. As an example, the workflow 500 may be implemented to build a 3D MEM that is “well-centric”, which may provide information germane to one or more well-centric processes such as, for example, hydraulic fracture design and evaluation, wellbore stability, sanding, etc. As an example, the workflow 500 may provide for a model with enhanced resolution in a lateral (e.g., horizontal) direction, which may be a direction along a lateral portion of a bore. For example, a bore may be drilled with a lateral portion, imaged, and a structural model constructed based at least in part on image data. In turn, the structural model may be used in conjunction with a 3D MEM process to enhance resolution in a neighborhood about the lateral portion of the bore.

The workflow 500 may include two or more portions, for example, consider a borehole structural geology portion 510, a geomechanics portion 550 and an application(s) portion 590.

In the workflow 500, the borehole structural geology portion 510 may generate a structural grid per a structural grid block 522 (e.g., a gridded representation of a structural setting), fault surfaces of faults per a faults block 526 and natural fractures per a discrete fracture network (DFN) block 530 (e.g., consider a collection of patches that represent a DFN).

In the workflow 500, the geomechanics portion 550 may include one or more modules that can build and/or solve equations using one or more techniques, such as, for example, one or more numerical techniques (e.g., consider the finite element method, etc.).

In the workflow 500, the application(s) portion 590 can include one or more applications that may, for example, utilize a multidimensional geomechnanical model and/or results of such a model as provided by the geomechanics portion 550, as well as, for example, one or more features of a geological model, such as a fracture network (e.g., a DFN), for example, as provided by the borehole structural geology portion 510. As an example, an application may be related to planning and/or one or more field operations.

As an example, one or more feedback loops may exist for the workflow 500 where, for example, results or other information acquired from an application of the application(s) portion 590 is utilized to revise one or more of the borehole structural geology portion 510 and the geomechanics portion 550 of the workflow 500. For example, consider a drilling operation that is performed based at least in part on output of the geomechanics portion 550 where the drilling operation acquires additional information as to borehole structural geology. In such an example, the additional information may be utilized to revise one or more outputs of the borehole structural geology portion 510 of the workflow 500. As an example, a logging while drilling (LWD) field operation (e.g., or measurement while drilling (MWD)) may acquire information that can be utilized to build and/or revise a multidimensional mechanical earth model (MEM), which may be part of the geomechanics portion 550 of the workflow 500. As an example, the workflow 500 may be dynamic and implemented in a real-time manner responsive to information gathered during one or more field operations and/or other operations. For example, real-time may be described as near real-time or pseudo real-time where information acquired is processed to provide output that can, in turn, be used to adjust one or more aspects of an operation such as a field operation (e.g., drilling, fracturing, etc.).

Referring again to the structural grid block 522, a gridded representation of a geologic environment (e.g., a structural grid or grids) may be conditioned, for example, per a grid conditioning block 554 of the geomechanics portion 550. As an example, conditioning of a grid for finite element modeling purposes may include processing referred to as “embedding”. As an example, conditioning can include one or more quality control processes, which may, for example, assess quality of one or more portions of a grid. As an example, to at last in part generate a multidimensional MEM per the static 3D MEM block 556, the geomechanics portion 550 can include mapping faults and natural fractures (see, e.g., the faults block 526 and the DFN block 530) into a conditioned grid, for example, by introducing mechanical joint(s) in grid cells that may be cut by one or more associated surfaces. As an example, the geomechanics portion 550 can, to at least in part generate a multidimensional MEM per the 3D MEM block 556, include populating a model (e.g., grid cells, grid nodes, surfaces, etc.) with one or more types of properties, values, etc. (e.g., consider mechanical properties and pore fluid pressures). For example, consider the density and sonic log processing block 560, the other information block 562, the rock properties block 564 and the faults and fractures properties block 568, which can provide information to the static 3D MEM block 556. As an example, boundary conditions per a boundary conditions block 570 can be applied to a multidimensional MEM of the 3D MEM block 556, which may include information pertaining to pore pressures per a pore pressures block 574 and/or information as to stress per a stress data block 584. In the geomechanics portion 550, a computation block 558 may compute stress for a multidimensional MEM, for example, via a process that includes solving a system of equations subject to boundary conditions, etc. The computation block 558 may output a stress field as a solution (e.g., over a region, regions, etc.) per a 3D stress field block 580. As an example, in an iterative manner, one or more boundary conditions of the boundary conditions block 570 may be tuned until a satisfactory match quality is obtained between modeled stresses and stress measurements and/or stress indicators that may be available.

As an example, where the computation block 558 includes computing stress using the finite element method, the geomechanics portion 550 of the workflow 500 may include receiving a structural grid and refining the structural grid at least horizontally and optionally vertically. For example, consider a method that includes refining a structural grid horizontally based at least in part on hydraulic fracture length and spacing information and refining the structural grid vertically based at least in part on heterogeneity of one or more observed properties. As an example, a structural grid may be expanded, for example, by adding one or more side-, over- and/or underburdens.

As an example, the geomechanics portion 550 of the workflow 500 may include populating a model with rock properties that may be, for example, derived from dipole sonic data, density and/or one or more other sources (e.g., consider populating with a variety of petrophysical properties). As an example, a process may include upscaling property profiles and distributing property values in one or more portions of a grid (e.g., as to surfaces, grid cells, grid nodes, etc.).

As an example, the geomechanics portion 550 of the workflow 500 may include mapping faults and natural fractures (e.g., an optionally artificial fractures) to one or more portions of a grid, for example, by identifying one or more grid cells that are at least in part penetrated by a discontinuity (e.g., a fault or a fracture). As an example, joints may be assigned to one or more grid cells (e.g., consider joints parallel to a local discontinuity orientation, etc.).

As an example, pore pressure (e.g., a pore fluid pressure field, etc.) may be based at least in part on one or more assumed hydrostatic conditions, for example, consider applying one or more pressure gradients, one or more constant pressures (e.g., as to weight of overburden surcharge, etc.), etc. As an example, pore pressure (e.g., a pore fluid pressure field, etc.) may be based at least in part on one or more reservoir flow simulations (e.g., via ECLIPSE™ simulator or other flow simulator).

As an example, boundary conditions may include one or more displacement and/or stress boundary conditions (e.g., applied to one or more lateral faces, etc.) and one or more internal boundary conditions (e.g., consider body forces). As an example, tuning may be applied to adjust one or more boundary conditions, for example, based at least in part on diminishing a difference between modeled and measured stresses.

As an example, a method may include receiving stress measurements and/or stress indicators that can be inverted to solve for values of one or more boundary conditions. In such an example, the one or more boundary conditions, when applied, may enhance matching between stress measurements and/or stress indicators and modeled stresses. For example, consider applying an inversion process in the geomechanics portion 550 of the workflow 500 to tune one or more boundary conditions 570. As an example, where information becomes available, a method may include performing one or more inversions based at least in part on such information and include applying one or more boundary conditions based at least in part on the one or more inversions. In turn, one or more processes may be planned, revised, etc. For example, consider revising a drilling plan, a drilling process, a fracturing plan, a fracturing process, etc.

As shown in the example of FIG. 5, the borehole/structural geology portion 510 of the workflow 500 includes an image processing and interpretation block 514, a modeling block 518 (e.g., for borehole structural geological modeling), the structural grid block 522, the faults block 526 and the discrete fracture network (DFN) block 530. In the example of FIG. 5, the grid conditioning block 554 of the geomechanical portion 550 may include conditioning a structural grid such as a structural grid of the structural grid block 552 of the borehole structural geology portion 510 of the workflow 500; noting that such a process may be part of the borehole/structural geology portion 510 or, for example, an intermediate portion of the workflow 500.

As an example, the grid conditioning block 554 may include one or more processes that prepare a grid for finite element modeling. For example, grid conditioning can include one or more of embedding, smoothing refinement and quality assessment. As to smoothing, consider a process that acts to smooth fault throws in a grid, for example, where the grid may be discontinuous across a fault such a process may make the grid more continuous across the fault. As to quality assessment, consider a process that may check one or more grid characteristics such as, for example, grid cell distortion, grid cell degeneracy, etc. A process may assess one or more dimensions, aspect ratios, etc. of one or more grid cells and optionally adjust one or more grid cells such to facilitate application of a numerical technique (e.g., a numerical solver). As an example, the grid conditioning block 554 may include grid refinement, for example, to refine resolution of a grid proximate to one or more structures, whether natural or artificial (e.g., wells, hydraulic fractures, etc.).

In the example of FIG. 5, the geomechanical portion 550 includes the static 3D mechanical modeling block 556, the density and/or sonic log processing block 560, the other information block 562, the rock properties block 564 and the fault and/or fractures properties block 568. As shown, information of the blocks 564 and 568 may be input to the block 556, which may include a model where information of the borehole structural geology portion 510 of the workflow 500 may be embedded therein (e.g., per the block 554). Further, as indicated, the blocks 526 and/or 530 may output information that may be integrated into a model and/or modelling of the block 556. As mentioned, boundary conditions may be set, for example, per the boundary condition block 570, which may also include information as to pore pressures, for example, per the pore pressure block 574. As an example, pore pressures may be variables that are determined with respect to a depositional model, a restoration model, etc. As mentioned, the computation block 558 may compute stress and, for example, output one or more stress fields per the 3D stress field block 580.

As an example, the aforementioned PETROMOD™ framework may include one or more modules that can predict pore pressure, for example, with respect to compaction (e.g., from past geologic times to present day). As an example, the PETROMOD™ framework may include a geomechanics module or modules (e.g., optionally as an add-on). In such an example, an analysis may be performed as to stress and/or strain distribution, influence of pore pressure, stress tensors, Mohr-cycle analysis, etc. As an example, secondary effects of pressure may be analyzed, for example, consider cementation of pore space, aquathermal expansion, mineral transformations, petroleum generation, fluid expansion, etc. An analysis may be based in part on information such as lithological properties, measured well and log data, etc. As an example, the block 558 may provide for modeling via a static 3D mechanical earth model (MEM) of the static 3D MEM block 556. As an example, the block 558 may include one or more modules for stress field modeling and optionally one or more modules for petroleum systems modeling.

In the example of FIG. 5, the computation block 558 may include outputting stress field information per the 3D stress field block 580. As an example, such information may be supplemented (e.g. integrated) with additional data, for example, per the stress data block 584. The output thereof (e.g., of blocks 580 and/or 584) may be utilized within the workflow 500, for example, in another iteration and/or utilized for one or more other purposes. As shown, output of the blocks 580 and/or 584 may be received as input to the block 570, for example, to adjust one or more boundary conditions.

As an example, the workflow 500 of FIG. 5 may include one or more additional portions, blocks, etc., optionally as one or more applications of the application(s) portion 590 of the workflow 500. For example, a hydraulic fracturing block may be provided that specifies one or more parameters associated with hydraulic fracturing. As mentioned, hydraulic fracturing may be considered to be a type of stimulation treatment that may be performed, for example, on oil and gas wells in low-permeability reservoirs. Such a treatment may include pumping engineered fluids at high pressure and rate into a reservoir via one or more bores, for example, to one or more intervals to be treated, which may cause a fracture or fractures to open (e.g., consider a vertical fracture that may include “wings” that extend outwardly from a lateral bore. Such wings may extend away from a bore in opposing directions, for example, according in part to natural stresses within a formation. As an example, proppant, such as grains of sand of a particular size (e.g., sizes, size distribution, etc.), may be mixed with a treatment fluid to keep a fracture (or fractures) open when a treatment is complete. Hydraulic fracturing may create high-conductivity communication with an area of a reservoir formation that can enhance production of hydrocarbons. As an example, stimulation treatment may occur in stages. For example, after completing a first stage, data may be acquired and analyzed for planning and/or performance of a subsequent stage. As an example, a lateral well may be used to perform a multistage fracturing process where data may be acquired and used in a model to output information germane to one or more stages of the multistage fracturing process. In such an example, the model may include a lateral resolution of the order of about one hundred meters where at least some fractures generated via the multistage fracturing process may be of lengths of the order of about one hundred meters or more.

Size and orientation of a fracture, and the magnitude of the pressure to create it, may be dictated at least in part by a formation's in situ stress field (see, e.g., block 580). As an example, a stress field may be defined by three principal stresses, which are oriented perpendicular to each other. The magnitudes and orientations of these three principal stresses may be determined by the tectonic regime in the region and by depth, pore pressure, temperature, rock properties, faults, fractures, etc., one or more of which may determine how stress is transmitted and distributed among formations.

In situ stresses can control orientation and propagation direction of hydraulic fractures, which tend to be tensile fractures that open in the direction of least resistance. As an example, if the maximum principal compressive stress is an overburden stress, then the fractures tend to be vertical, propagating parallel to the maximum horizontal stress when the fracturing pressure sufficiently exceeds the minimum horizontal stress.

As the three principal stresses tend to increase with depth, the rate of increase with depth can define a vertical gradient. The principal vertical stress, referred to at times as overburden stress, is caused by the weight of rock overlying a measurement point. Its vertical gradient is known as the litho-static gradient. The minimum and maximum horizontal stresses are the other two principal stresses. Their vertical gradients, which may vary widely by basin and lithology, tend to be controlled by local and regional stresses, mainly through tectonics.

The weight of fluid above a measurement point in normally pressured basins creates in situ pore pressure. The vertical gradient of pore pressure is the hydrostatic gradient. However, pore pressures within a basin may be less than or greater than normal pressures and are designated as underpressured or overpressured, respectively.

At the surface, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length). As an example, a geomechanical model may provide for evaluation of one or more thresholds (e.g., pertaining to pressure, stress, etc.).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

A workflow may include one or more tasks (e.g., worksteps) associated with designing a hydraulic fracture treatment. For example, a design or plan can include one or more of location, type, orientation and number of perforations per fracture (e.g., consider a perforation cluster), number and location of perforation clusters in a well (e.g., consider a hydraulic fracturing stage), pumping schedule (e.g., consider type of fluids and solids, volumes and rates) and a well cleanup schedule.

For fracturing conventional reservoirs, such a workflow may include establishing a leakoff rate and volume of a pad in relation to timing of slurry and proppant injection so that when a fracture reaches its designed length, height and width, the first particle of proppant reaches the fracture tip. As an example, for an unconventional reservoir, such a workflow may include establishing a flow rate and a proppant volume to create a desired network of propped and unpropped fractures. To design a hydraulic fracturing job, a workflow may provide for an understanding of how pumping rate and stimulation fluid properties affect hydraulic fracture geometry and propagation within the in situ stress field to achieve a targeted propped fracture length. For example, output from the block 580 may be input to one or more blocks associated with hydraulic fracturing.

As an example, as to design of stimulation treatments, an aspect may include control of fracture propagation, for example, to help ensure that a hydraulic fracture stays within a reservoir and does not grow into an adjacent formation. To reduce such risk, monitoring may be performed during an operation (e.g., to monitor fracture growth). For example, as fracturing fluid forces the rock to crack and fractures grow, small fragments of rock break, causing tiny seismic emissions, called microseisms. Equipment may be positioned in a field, in a bore, etc. to sense such emissions and to process acquired data, for example, to locate microseisms in the subsurface. Information as to direction of fracture growth may allow for actions that can “steer” a fracture into a desired zone(s) or, for example, to halt a treatment before a fracture grows out of an intended zone.

The propagation of hydraulic fractures adheres to laws of physics. In situ stresses tend to control pressure and direction of fracture initiation and growth. Further, monitoring of a stimulation process can help ensure that it occurs safely, where risks may be managed in planning and, for example, actively managed in the field.

Referring again to the workflow 500, a block may be included that receives input information from a field operation. For example, consider a hydraulic fracturing operation where microseismic energy is monitored and transmitted to a workflow such as the workflow 500. Such information may provide for updating one or more boundary conditions, optionally by providing stress data.

As an example, a workflow may include receiving information as to one or more desired dimensions of a hydraulic fracture. In such an example, the one or more desired dimensions may be used to determine a resolution or resolutions as to a model of a geologic environment. As an example, a resolution may correspond to one or more dimensions of a finite element that may be used in a finite element method (e.g., a numerical technique that may be used to solve equations subject to one or more boundary conditions).

As an example, a workflow may output information as to a determined dimension or dimensions of a hydraulic fracture. In such an example, a field operation may be performed that generates one or more hydraulic fractures. Such an operation, during and/or after, may provide information germane to stress, which may be input to the workflow. In such an example, the workflow or portion thereof may perform calculations based on at least a portion of the information, which, in turn, may be output for purposes of a subsequent field operation (e.g., further fracturing such as in another stage, another region, etc.).

As an example, a workflow may include integration of borehole imagery and seismic data to determine structural features that may be embedded in a finite element model, for example, to provide a desired resolution of the model with respect to one or more of such structural features. In such an example, the model with the embedded structural features (e.g., mathematical representations thereof) may be solved, for example, to determine stress information where such stress information may be at the desired resolution (e.g., in a region extending from one or more boreholes, etc.). As an example, based at least in part on the stress information, a stimulation treatment process may be undertaken, for example, according to a plan. After such a process, a production phase may commence where one or more resources are recovered from a geologic environment as treated by the stimulation treatment process.

As an example, a workflow may include simulating a signature on one or more monitoring sensors, for example, as to expected and/or unexpected events. In such an example, one or more monitoring sensors may be positioned at surface and/or downhole and/or airborne (e.g., drone, aircraft, satellite, etc.). Sensors may include, for example, one or more of pressure gauges, geophones or accelerometers, optical fiber sensors, tiltmeters, GPS/InSAR systems, etc. As an example, events may concern the reactivation of natural fractures or faults, the propagation of hydraulic fractures, including in undesired zones, the opening or closure of flow paths in the formations. A signature may include the response expected to be recorded by a sensor. For example, such a response may include a magnitude and/or a shape. As an example, a signature may also include the expected spatial and/or temporal location of a response.

As an example, a workflow may include analyzing sensitivity of one or more signatures, for example, with respect to sensor location and orientation and with their relative location and orientation when a network of sensors is deployed. Such an analysis may include a comparison between expected signatures from at least one of one or more sensors and, for example, the detection threshold and the range of at least one sensor. As an example, such analyses may be used to design and construct one or more monitoring systems, for example, with an ability to capture desired events at a sufficient level of confidence. As an example, such analyses may be used to interpret monitoring data, for example, to identify one or more events according to their signature or to identify one or more events that may not match an expected signature, or to classify one or more events depending on how close an event may be from an expected signature or depending on spatial and/or temporal occurrence.

As an example, a workflow may include a calibration step whereby signatures forecast by a model are compared with observations and/or measurements taken at ground level, in one or more existing wells, and/or via one or more airborne sensors (e.g., drone, aircraft, satellite, etc.), for example, where one or more discrepancies are evaluated. As an example, one or more model parameters and/or simulation parameters may be adjusted to reduce a discrepancy or discrepancies.

Below, various techniques, technologies, etc. are described that may optionally be included in a workflow, for example, such as the workflow 500 of FIG. 5. As an example, various techniques, technologies, etc. may be implemented as part of a workflow, which may include inputting to a portion of the workflow 500, receiving output from a portion of the workflow 500, etc.

As an example, a workflow can include receiving borehole-wall image data, processing the image data and interpreting the processed image data. As an example, an interpretation process may be manual, semi-automated or automated. As an example, an interpretation process can include identifying structural dips that correspond to positions along a length of a bore. As an example, adjacent dip readings may be grouped into sequences in a manner such that dips within a given sequence are internally consistent with a cylindrical or conical structure. In such an example, a cylindrical or conical structure may be fit to a corresponding set of dips, for example, to yield structural parameters of a sequence. As an example, as a structural element associated with a sequence may be seen at a bore over a certain bore length, it may be extrapolated away from the bore to a particular distance. As an example, features such as faults, natural fractures, etc. may also be identified via image data, for example, for purposes of modeling such features (e.g., consider fault and fracture network modeling).

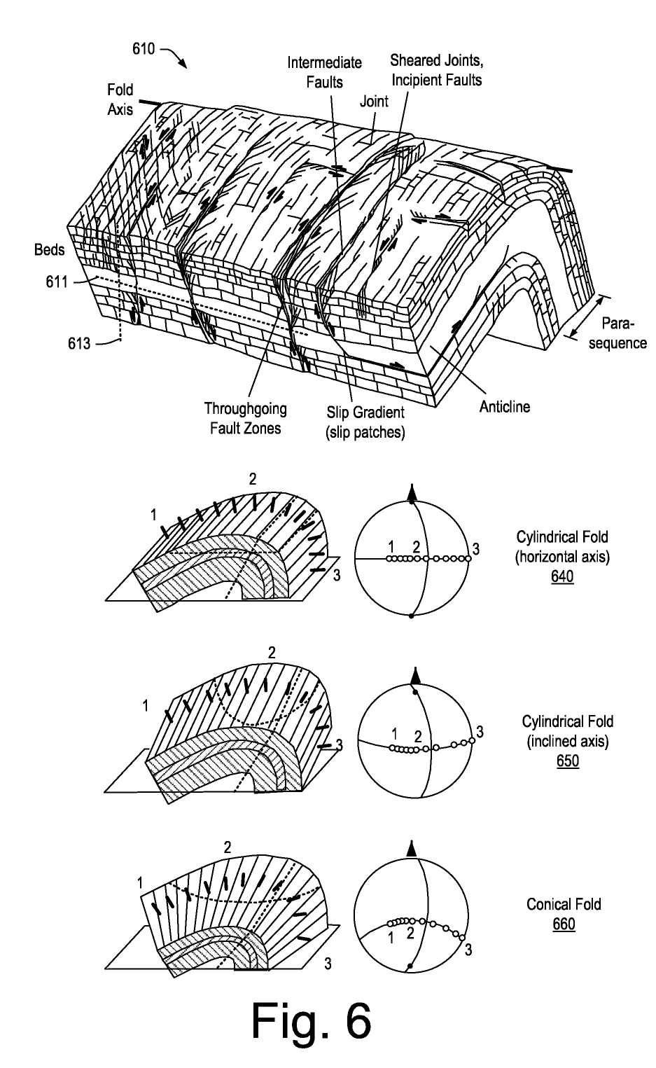

FIG. 6 shows an example of a geologic environment 610 and various examples of types of folds including a cylindrical fold with a horizontal axis 640, a cylindrical fold with an inclined axis 650 and a conical fold 660. The geologic environment 610 includes various types of features set about an anticline that can define a fold axis. As shown, the geologic environment includes beds, at least one parasequence, joints, sheared joints, incipient faults, throughgoing fault zones, intermediate faults, a slip gradient and slip patches. FIG. 6 also shows a substantially lateral path 611 and a substantially vertical path 613. The substantially lateral path 611 may be substantially parallel to at least a portion of the fold axis of the anticline. As an example, the substantially lateral path 611 may pass through more throughgoing fault zones that the substantially vertical path 613.

As an example, an anticline may be defined as an arch-shaped fold in rock in which rock layers are upwardly convex. In such an example, the oldest rock layers can form a core of the fold, and outward from the core progressively younger rocks can occur. An anticline formation may act as a hydrocarbon trap, particularly when existing with reservoir-quality rock in a core and impermeable seals in outer layers. As an example, a bore may be drilled at least in part in a direction substantially parallel to fold axis (e.g., to produce hydrocarbon from a trap).

The example types of folds 640, 650 and 660 of FIG. 6 illustrate how bedding planes' poles picked within a cylindrical or conical structure align themselves on so-called great or small circles, in a stereonet view. These examples demonstrate that for a given structure, an approximation may be constructed via a cylinder or a cone.

As an example, dip readings interpreted on image data may be sequenced in a manner such that adjacent dips within a sequence are located along a great or a small circle (e.g., or close to it), which thus provides for illustrating an association with a particular structural element. As an example, structural elements may be reconstructed, for example, as may be seen in a vertical cross section through a geologic environment.

As an example, a substantially horizontal portion of a bore, a well, etc. may be characterized via one or more parameters. For example, consider a kickoff parameter, a heel parameter, a toe parameter. As an example, a substantially horizontal portion of a bore, a well, etc. may be characterized by a toe-up, a toe-down, etc. As an example, a heel may be a point in a horizontal bore trajectory where inclination angle reaches approximately 90 degrees. As an example, a toe may be a point that represents a depth of a horizontal bore. As an example, a toe-up profile may be achieved where inclination angle is more than about 90 degrees throughout a horizontal portion and a toe-down profile may be achieved where inclination angle is less than about 90 degrees in a horizontal portion. As an example, a substantially horizontal portion or a substantially lateral portion may be of an overall inclination angle of about 90 degrees; for example, consider an inclination angle in a range from about 75 degrees to about 105 degrees or, for example, in a range from about 80 degrees to about 100 degrees or, for example, in a range from about 85 degrees to about 95 degrees. As an example, a profile of a bore may be shaped in a manner that aims to maintain the bore in a pay zone or pay zones (e.g., to maximize exposure to a reservoir or reservoirs).

As an example, a bore may be drilled using a so-called horizontal drilling technique, which may be a subset of directional drilling techniques. As an example, a horizontal drilling technique may be implemented to achieve a bore with a portion that departs from vertical by about 75 degrees or more. As an example, horizontal drilling may be implemented to penetrate a greater length of a reservoir or reservoirs (e.g., in comparison to a vertical bore). For example, consider the formation 610 of FIG. 6 where horizontal drilling may be implemented to drill a bore in a direction that is substantially parallel to a fold axis of the anticline. As mentioned, an anticline may act as a trap; noting that particular features can exist in such a formation (e.g., faults, natural fractures, joints, etc.). As an example, a horizontal drilling technique may be implemented to drill a bore with a lateral extent that may be in a reservoir formed in part due to a trap such as an anticline trap. In such an example, a lateral extent of the bore may pass through a plurality of faults (e.g., fault zones, etc.) and, where a sub-surface tool is disposed in the lateral extent of the bore, data may be acquired germane to the location of such faults. As an example, such sub-surface tool data may be analyzed for the location of at least one fault where a method may extrapolate the location a distance (e.g., or distances) and a direction (e.g., or directions) away from the lateral extent of the bore (e.g., for purposes of conditioning a geomechanical model, etc.).

As an example, a substantially lateral portion of a well may intersect one or more natural fractures, contact one or more resource containing formations, allow for generation of one or more hydraulic fractures, etc. Horizontal drilling may include use of equipment such as, for example, one or more of whipstocks, bottomhole assembly (BHA) configurations, instruments to measure the path of a bore in multiple spatial dimensions, data links to communicate measurements taken downhole to the surface, mud motors and special BHA components, including rotary steerable systems and drill bits. As an example, a geologic environment may include hydrocarbon gas (e.g., shale gas, etc.).

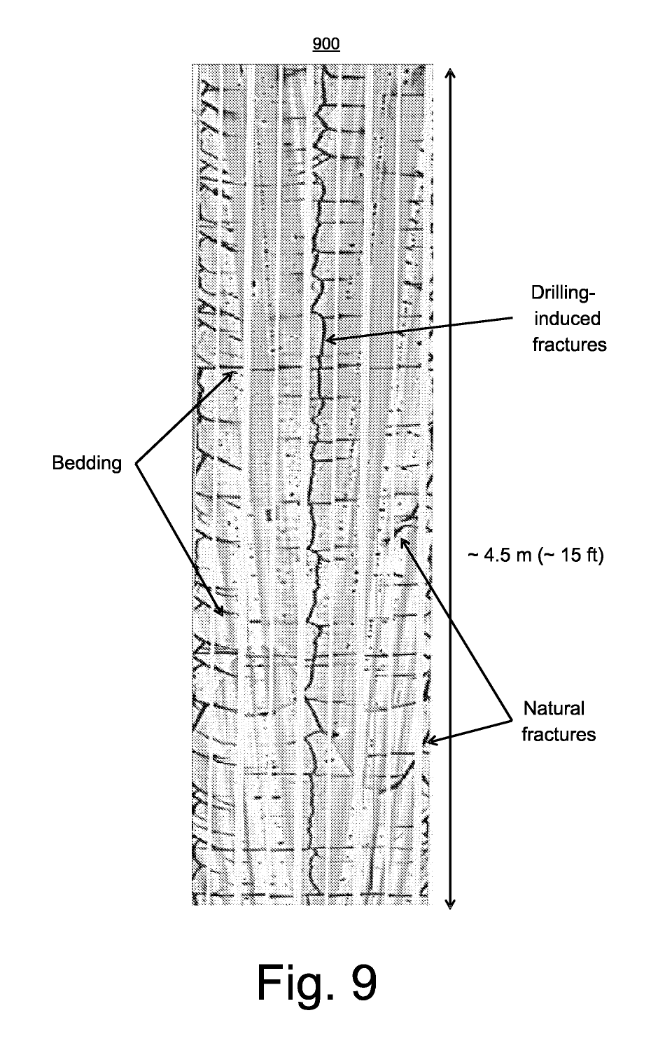

As an example, a drilling operation may drill into a geologic environment at a rate measured in distance per unit time. For example, consider a drilling operation that drills a substantially lateral bore at an average rate of the order of about a meter per minute. As an example, consider a plan that specifies a lateral portion of a bore to be of a length of about 1,000 meters. Where an average drilling rate is about 1 meter per minute, such a lateral portion of a bore may be drilled in about 17 hours (e.g., about 1000 minutes). As mentioned, a real-time workflow may include acquiring data and processing that data to adjust an operation. Where an operation is drilling, data may be acquired while drilling, transmitted and processed to provide output germane to the drilling in a period of time of the order of minutes. For example, consider acquiring five minutes of data that correspond to about 5 meters of bore (see, e.g., the data of FIG. 9 as to structural features in a length of about 5 meters), transmitting the data, processing the data and adjusting the drilling. Such a workflow may be part of a workflow loop where the transmitting and processing are achieved in a period of time of the order of minutes to allow for adjusting the drilling with a “lag” time of the order of minutes. Such a workflow may be considered a real-time workflow or a near real-time workflow. Such a workflow may be implemented using one or more of the blocks of the workflow 500 of FIG. 5 (e.g., where drilling, and acquiring data, may be considered an application of the application(s) portion 590). As an example, an adjustment to a drilling operation may include, for example, an adjustment to one or more of drill speed, drill rate, mud flow, inclination, data acquisition rate, type of data acquisition, etc.

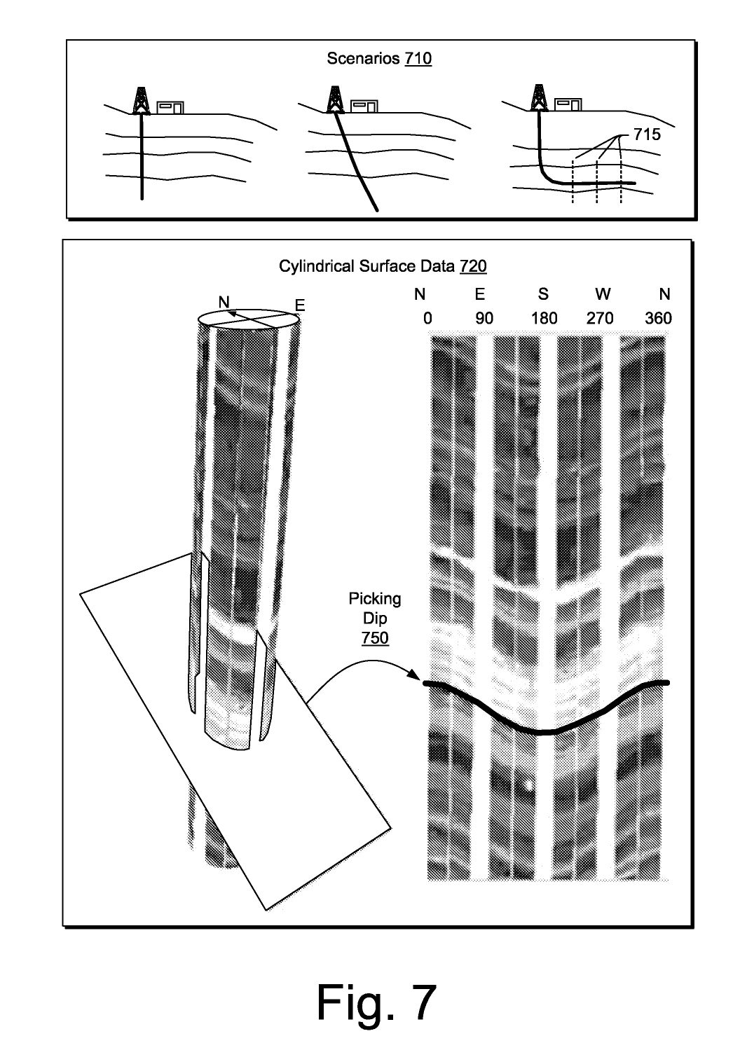

FIG. 7 shows some examples of scenarios 710, an example of three-dimensional (3-D) cylindrical surface data 720 (e.g., borehole-wall image data) and a plane intersecting a cylinder corresponding to the data 720 where the plane may be a bedding plane. The scenarios 710 illustrate a relatively vertical bore, a deviate bore and a bore that includes a lateral or horizontal portion, which may be used, for example, for stimulation (e.g., fracture formation 715) and/or one or more other purposes. Surface data may be acquired by positioning a tool in a bore such as, for example, one of the bores of the example scenarios.

As an example, bore data (e.g., imagery, etc.) may be presented in a 2-D format for purposes of analysis, interpretation, etc. In FIG. 7, various materials (e.g., beds, fractures, or other features) may be seen and, for materials being substantially planar with respect to intersection of a bore, these materials tend to have a sinusoidal shape when viewed in a 2-D format. In a process referred to as picking dips (e.g., dip identification), the cylindrical surface data 720 may be presented on a display where a “sine” cursor tool allows a user to adjust amplitude, position along a z-axis, etc., of a sinusoidal curve to align it with the data for the stratified material. In particular, the sinusoidal curve may be positioned where image contrast (e.g., or other attribute) differs to a certain extent, for example, to represent differences in resistivity or one or more other properties of the material. As an example, another way to achieve this is by clicking three or more times along the plane as seen on an image and letting a computing device mathematically connect the points using a sinusoid equation. While “sine” may be mentioned, a cosine or other appropriate function may be employed. Other methods also exist for dip identification.

As an example, a dip picking process may be implemented to determine dip (e.g., magnitude and azimuth) of one or more planes, and may be a part of a standard workflow when analyzing borehole data (e.g., borehole images).

As an example, the data 720 may include information that is germane to stress in a geologic environment. For example, particular features may indicate that a particular type of geological environment stress exists (e.g., drilling induced fractures, compression failures, tensile failures, induced fractures, breakout failures, etc.). As an example, analysis of such information may assist with stress field calculations, which may be used in a stimulation treatment (e.g., planning, delivery, etc.).

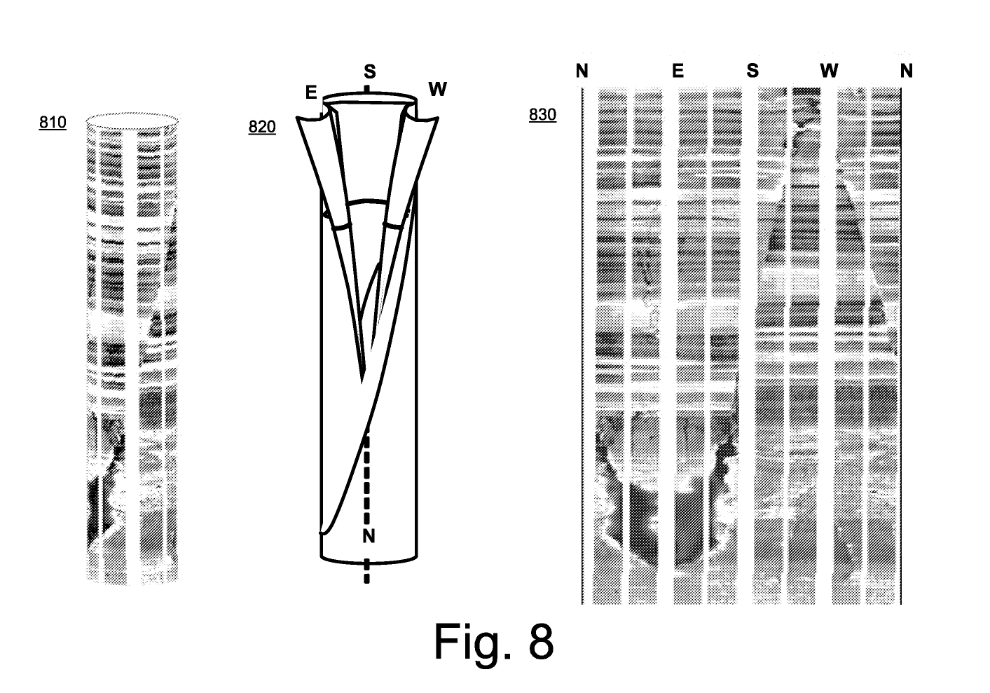

FIG. 8 shows an example of image data 810, image processing 820 and processed image data 830. In the processed image data 830, a fault can be identified offsetting the bedding. The fault may also be identified in the image data 810 as a diagonal plane extending from upper right to lower left (e.g., dipping W to E in the processed image data 830).

FIG. 9 shows an example of processed image data 900. As shown in FIG. 9, the data 900 allows for identification of features such as bedding, drilling induced fractures and natural fractures. In the example of FIG. 9, the data 900 corresponds to a length of about 4.5 meters (e.g., about 15 feet). Such data illustrates proximity of features with respect to distance of a bore.

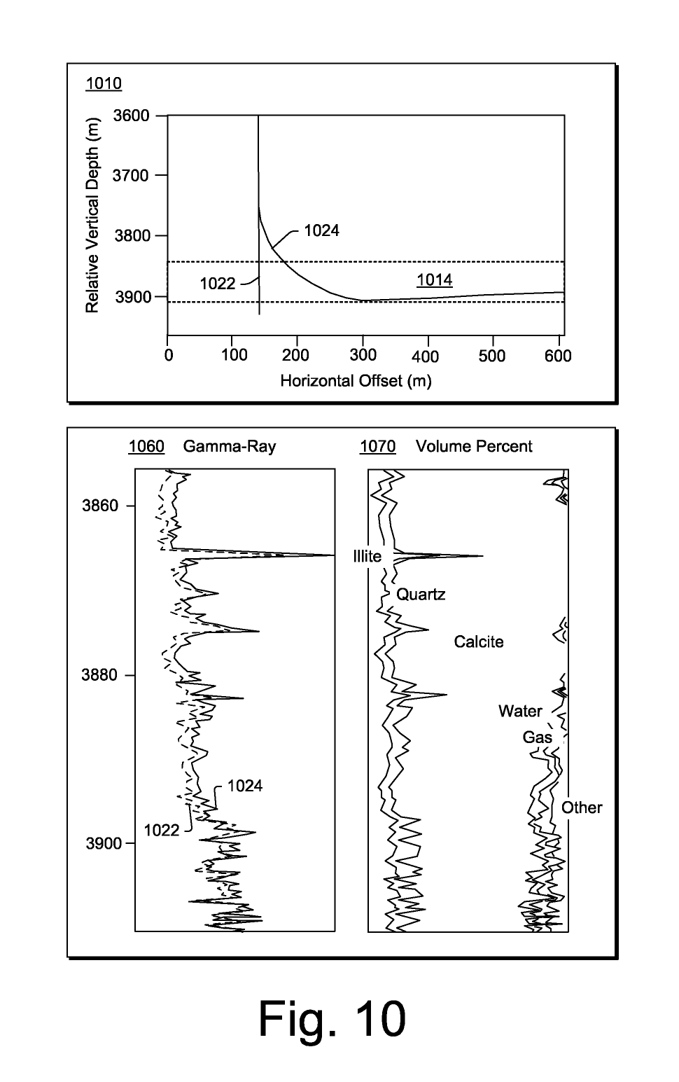

FIG. 10 shows an example of a plot 1010 of well with a vertical portion 1022 and with a horizontal portion 1024 (e.g., a production portion) in a formation 1014 with respect to relative vertical depth in meters and horizontal offset in meters. As an example, the horizontal portion 1024 may be a leg; alternatively, a vertical bore may be drilled along with another bore that forms a horizontal portion. For example, a vertical bore may be drilled and data acquired via a sub-surface tool disposed in the vertical bore and a bore with a substantially horizontal portion may be drilled and data acquired via a sub-surface tool disposed in the substantially horizontal portion.

FIG. 10 also shows plots 1060 and 1070 for associated gamma-ray logs and lithology logs, respectively, for example, after performing a depth correlation process (e.g., using data acquired in portion 1022 and portion 1024). As shown in the plot 1070 of volume percent versus depth, the lithology logs indicate layers of illite (e.g., a non-expanding, clay-sized, micaceous mineral), quartz, calcite, water, gas and other. At depths greater than about 3880 meters, volume percent of water and gas increases.

As an example, such information may be used as part of a structural analysis as to one or more features in a geologic environment. For example, such information may be analyzed for purposes of embedding information in a finite element model. As an example, where the horizontal portion 1024 is suited for delivery of a stimulation treatment such as hydraulic fracturing, a finite element model that includes structural representations therein derived from log data (e.g., acquired from the horizontal portion 1024) may be solved using a finite element technique to provide stress field information that may assist in planning, delivery, etc. of such a treatment.

As an example, a workflow can include acquiring measurements versus depth, distance and/or time of one or more physical quantities in or around a bore. As an example, measurements can include wireline logs, which may be taken via one or more downhole sensors (e.g., one or more sub-surface sensors, etc.). In such an example, information may be transmitted through a wireline, for example, to surface equipment, which may optionally transmit such information (e.g., raw and/or processed). As an example, measurements-while-drilling (MWD) and/or logging while drilling (LWD) information may be acquired via one or more downhole tools (e.g., one or more sub-surface tools). As an example, information may be transmitted via one or more techniques (e.g., mud pulses, downhole recording, wireless transmission, etc.). As an example, a mud log may include information that can describe drilled cuttings, for example, representative of material in an environment being drilled.

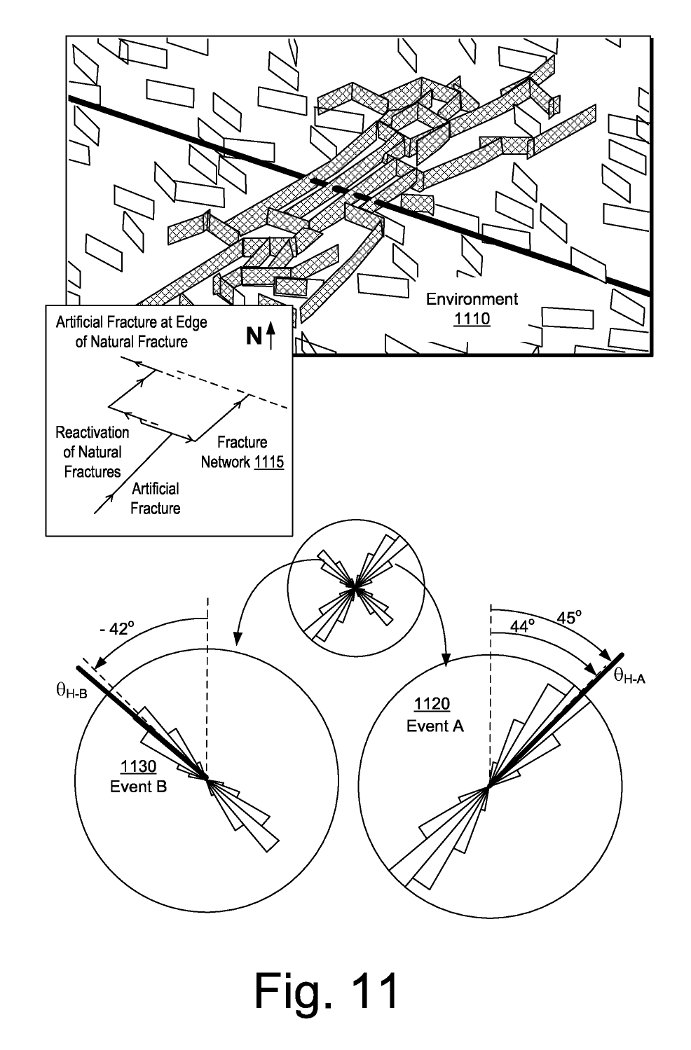

FIG. 11 shows an example of an environment 1110, an example of a fracture network 1115 and examples of rose diagrams 1120 and 1130. As shown, the environment 1110 includes a well, natural fractures and artificial fractures that interconnect with a portion of the natural fractures. As an example, a well or borehole may include one or more lateral or horizontal portions, which may be suitable for delivery of a stimulation treatment, production of a resource, etc.

In the example of FIG. 11, the fracture network 1115 includes natural fractures (e.g., or faults, optionally including active faults) and artificial fractures. As an example, creation of a hydraulic fracture may be impacted by one or more natural fractures (e.g., or faults). For example, hydraulic fracture growth may proceed in a northeast-southwest direction that reactivates natural fractures (dashed lines) trending in another direction or directions (see, e.g., arrows indicate possible propagation directions of hydraulic fractures). As an example, a network may be a stimulated fracture network that may include at least one hydraulic fracture. As an example, a reactivated fracture network can include at least one fracture that is created adjacent a borehole where the fracture can extend to one or more existing fractures to form network (e.g., reactivating at least one or more natural fractures). As an example, a field operation may include shearing in a geologic environment to reactivate one or more natural fractures.

As an example, data may be acquired and analyzed to identify one or more events, for example, consider Event A and Event B, which may be events of past geologic time (e.g., or optionally associated with more recent time, including, as an example, fracturing). As an example, let θ_{H} be the orientation of the maximum principal horizontal far field stress according to a direction (e.g., north), θₜₕₑₒ be the theoretical strike orientation of a fracture in the perturbed stress field due to slipping faults and θ_{obs} be its observed strike orientation (according to the north). In such an example, an estimate of the angle θₜₕₑₒ may be computed using, for example, a three-dimensional geomechanical application (e.g., consider one or more of the IBEM3D™, POLY3D™, DYNEL™ software applications, Schlumberger Limited, Houston, Tex.). However, as a far field stress is involved, a stress inversion may be performed. As mentioned, a method may include inverting information to obtain one or more values that may be suitable for use as one or more boundary conditions of a model.

As an example, a recovered paleostress based on observations (e.g., measurements) may be given with an orientation (e.g., N161) and, for example, with a ratio that may be used in conjunction with a definition of a tectonic regime to characterize faulting (e.g., normal, strike slip, thrust, etc.). As an example, after a paleostress has been resolved, a predicted fracture pattern may be computed, for example, via lines perpendicular to local least compressive stress. As an example, such computations may provide output via an observation grid that may be compared to one or more observed fracture patterns.

As an example, an inversion may be performed using data such as, for example, secondary fault plane data. For example, a secondary fault plane may develop in the vicinity of larger faults. As an example, two conjugate failure planes may intersect along σ₂ where fault orientation is influenced by orientation of the principal stresses and friction (e.g., consider an internal friction angle). In such an example, models and cost function minimization may be performed to recover the state of stress at an observation point P (e.g., tectonic regime, stress ratio, and orientation). As an example, a stress ratio may be defined to be σ_{H}/σₕ.

As an example, fault striations may be used as data for performing an inversion to recover information about a tectonic regime. As an example, magnitude information may be used as data for performing an inversion to recover information about a tectonic regime. As an example, GPS data and/or InSAR data (interferometric synthetic aperture radar) may be used for performing an inversion to recover information about a tectonic regime. As an example, flattened horizon data may be used for performing an inversion to recover information about a tectonic regime. As an example, dip-slip data (e.g., from seismology) may be used for performing an inversion to recover information about a tectonic regime. As an example, one or more types of data may be provided and optionally weighted (e.g., by type, etc.) for performing one or more inversions to, for example, recover information about a tectonic regime (e.g., paleostress).

As to an analysis, mathematical inversions may provide information as to σ_{H-A}, θ_{H-A} and σ_{H-B}, θ_{H-B}. In turn, it may be possible to compute θ_{theo-A} and θ_{theo-B}. In such an example, two populations (e.g., sets) of fractures may be uncovered and presented in their respective undisturbed states (see, e.g., the rose diagram 1120 for Event A and the rose diagram 1130 for Event B).

As an example, the POLY3D™ software package may be implemented for forward stress modeling, for example, using one or more modules. As an example, such a package may implement a boundary element method (BEM). Such a package may provide for characterization and modeling of subseismic fractures, which may facilitate better drilling decisions (e.g., using fundamental principles of physics that govern rock deformation). For example, output may include modeled density and orientation of subseismic faults in a region (e.g., which may include a reservoir or reservoirs).

As an example, a package may provide for 3D fault modeling. In such an example, a workflow may aim to identify regions of hydrocarbons for possible recovery. Multi-dimensional fault modeling may facilitate building and/or supplementing a geologic model of reservoir structure. Forward capabilities in the Poly3D software package may help to reduce uncertainty in seismic interpretation of complex fault networks and allow more accurate underconstrained complex geological models to be built.

As to natural fracture modeling, a package may provide for modeling of natural fractures in unconventional reservoirs, for example, in a manner that accounts for physics of fracture development through time. A package may include one or more modules for computation of heterogeneous stress fields through time to reveal their impact on seal integrity and product, as well as to model subseismic fractures and faults.

As to well design, drilling in structurally complex reservoirs can present challenges, especially when the area is tectonically active. A package such as the POLY3D™ software package may provide for creation of multi-dimensional models, for example, of present-day heterogeneous stress fields that may be caused by active faulting and salt diapir.

A package may include one or more modules as to structural models, which may include hundreds of faults, which may be presented and handled independently from complexity of a fault network (e.g., consider multiple X, Y, and thrust faults). As an example, multi-dimensional discontinuities (e.g., joints, sedimentary layers, cavities, and salt bodies) may be modeled, for example, using triangular dislocation technology.

As an example, a system may provide for one or more of modeling 3D loading conditions representing a tectonic regime (e.g., normal, thrust, or strike-slip fault), gravity field, and effective stress; computing fault mechanical interaction in response to the applied tectonic loading (e.g., as opposed to standard elastic dislocation methods); computing displacement, strain and stress fields, and associated attributes in a surrounding volume (e.g., on the Earth's surface, on seismic horizons, along well paths, at reservoir grid nodes, at cross sections, or at volumes); running simulations at a reservoir scale, which may allow for sensitivity analysis of the results; etc.

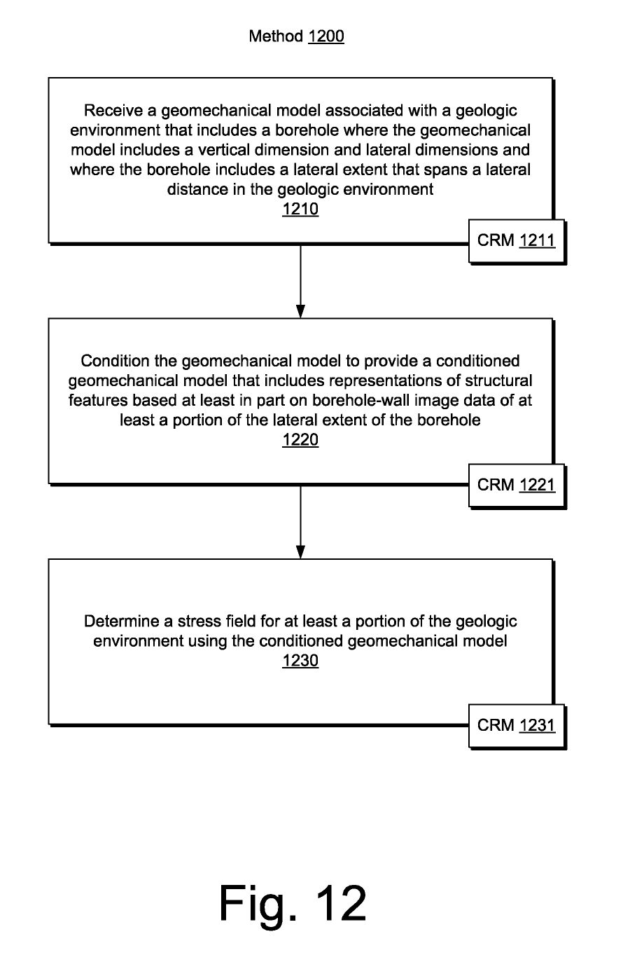

FIG. 12 shows an example of a method 1200 that includes a reception block 1210 for receiving a geomechanical model associated with a geologic environment that includes a borehole where the geomechanical model includes a vertical dimension and lateral dimensions and where the borehole includes a lateral extent that spans a lateral distance in the geologic environment; a condition block 1220 for conditioning the geomechanical model to provide a conditioned geomechanical model that includes representations of structural features based at least in part on borehole-wall image data of at least a portion of the lateral extent of the borehole; and a determination block 1230 for determining a stress field for at least a portion of the geologic environment using the conditioned geomechanical model.

As shown in FIG. 12, the method 1200 may be associated with various computer-readable media (CRM) blocks 1211, 1221 and 1231. Such blocks generally include instructions suitable for execution by one or more processors (or cores) to instruct a computing device or system to perform one or more actions. As an example, a single medium may be configured with instructions to allow for, at least in part, performance of various actions of the method 1200. As an example, a computer-readable medium (CRM) may be a computer-readable storage medium that is non-transitory and that is not a carrier wave. As an example, blocks may be provided as one or more modules, for example, such as the one or more modules 270 of the system 250 of FIG. 2.

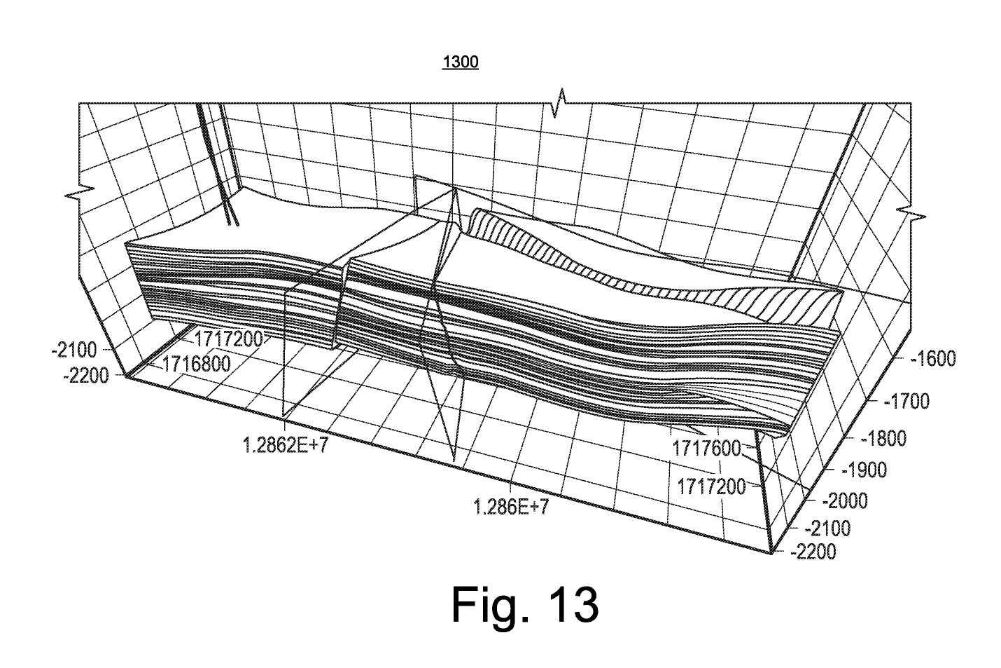

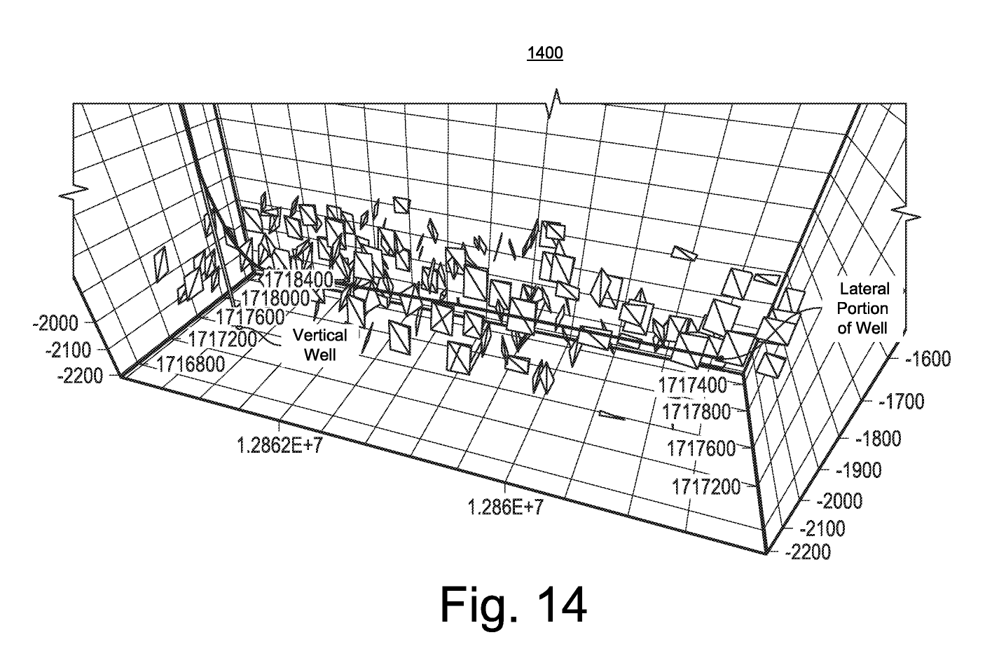

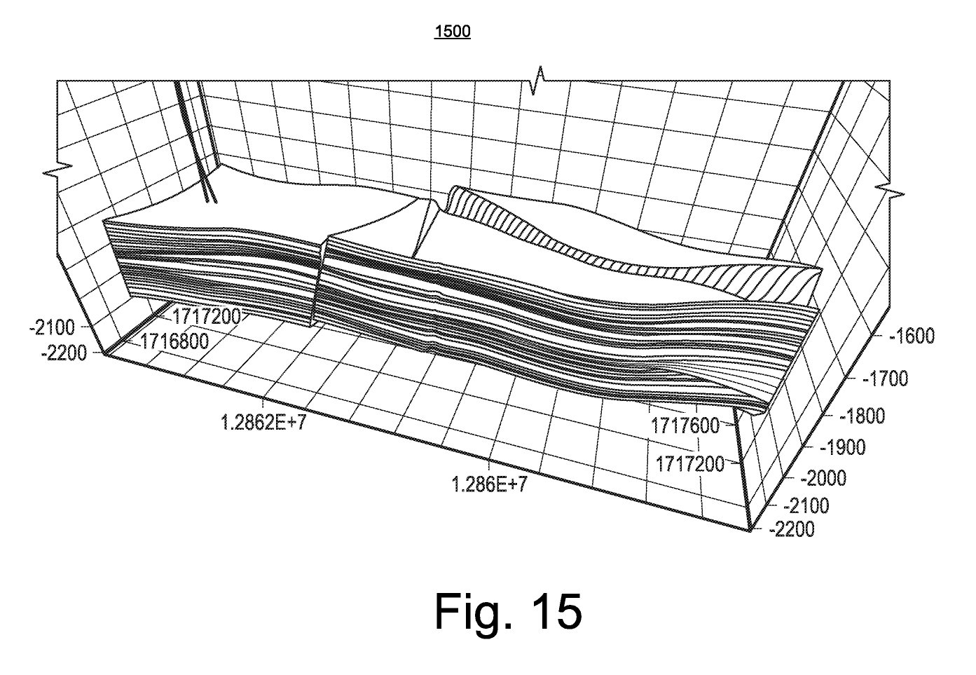

FIG. 13 shows an example of a model 1300 that is a structural model that includes faults. FIG. 14 shows an example of a discrete fracture network (DFN) 1400. FIG. 15 shows a model 1500 along with information as to magnitude of least compressive principal stress. As to resolution, in the examples of FIGS. 13, 14 and 15, elements are about 300 ft-thick (e.g., about 100 m) with horizontal dimensions of about 1500 ft to about 5000 ft (e.g., about 500 m to about 1700 m).

FIGS. 13, 14 and 15 also show bore paths. For example, FIG. 14 shows a first bore path as being relatively vertical and a second bore path as including a relatively horizontal portion. As an example, a horizontal portion may be directed into one or more formations in a geologic environment. As an example, a bore such as that represented by the second bore path may provide for delivery of fluid to stimulate a formation (e.g., consider a stimulation treatment such as a hydraulic fracturing stimulation treatment).

In FIG. 13, the model 1300 includes three faults, which are included in the model 1300 based at least in part on processing of image data (e.g., image log interpretation). For example, consider the workflow 500 of FIG. 5 where image data can be processed to identify various structural features. In FIG. 13, the model 1300 includes such structural features, which are further extrapolated various distances from the wells, for example, to enhance the model 1300 in regions that may be hydraulically fractured, etc. Various features identified via borehole-wall image data are not readily identified via seismic data, which demonstrates how borehole-wall image data may be used to enhance a model.

As an example, processing of borehole-wall image data may provide information as to natural fracture orientation and distribution, for example, to facilitate generation of a discrete fracture network (DFN). Referring to FIG. 14, the DFN 1400 is based at least in part on processing of borehole-wall image data. Some of the fractures within the DFN 1400 of FIG. 14 may be associated with fault-related fracture corridors, for example, consider a fracture set along one fault and another fracture set along another fault. As explained with respect to the workflow 500 of FIG. 5, a structural model, faults and a DFN may be passed as input to a geomechanical model building process.

Referring to FIG. 15, the model 1500 is built via conditioning, for example, via “embedding” information from a structural model into a 3D MEM. As mentioned, information from a structural model can be used to enhance resolution of a 3D MEM, particularly in one or more regions proximate to a well or wells.

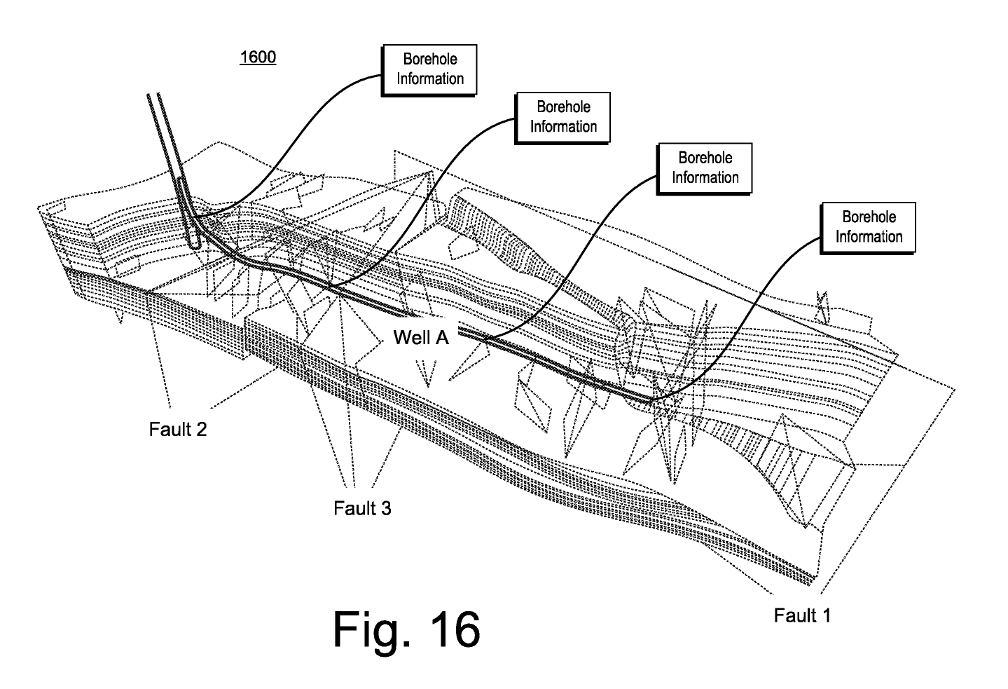

FIG. 16 shows a perspective view of an example of a model 1600 along with information acquired via bores. The model 1600 includes information pertaining to borehole structural geology. Such information is based at least in part on processing of borehole-wall image data, particularly image data from a lateral portion of a bore. A model such as the model 1600 may include information that is based at least in part on processing of seismic data.

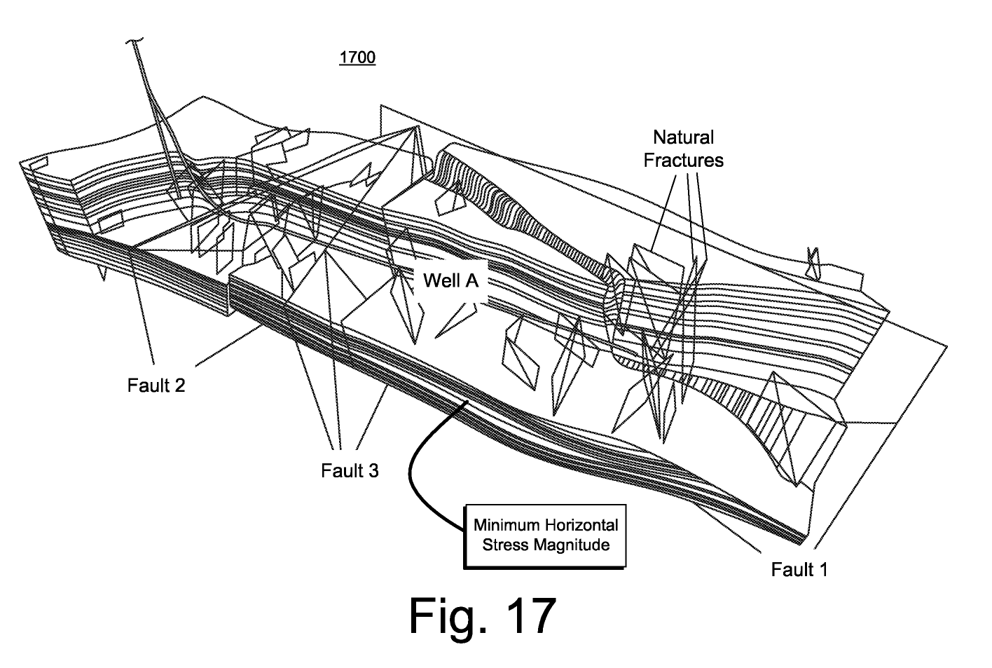

FIG. 17 shows a perspective view of an example of a model 1700 that is conditioned based at least in part on the information of the model 1600 of FIG. 16. The model 1700 can provide for geomechanical modeling via a numerical solution technique such as the finite element method. As an example, a model such as the model 1700 may include and/or be based at least in part on one or more of density and sonic log data, stress measurements, pore pressure data, and faults and fractures mechanical data. As an example, the model 1700 of FIG. 17 may be used to solve for minimum horizontal stress magnitude.

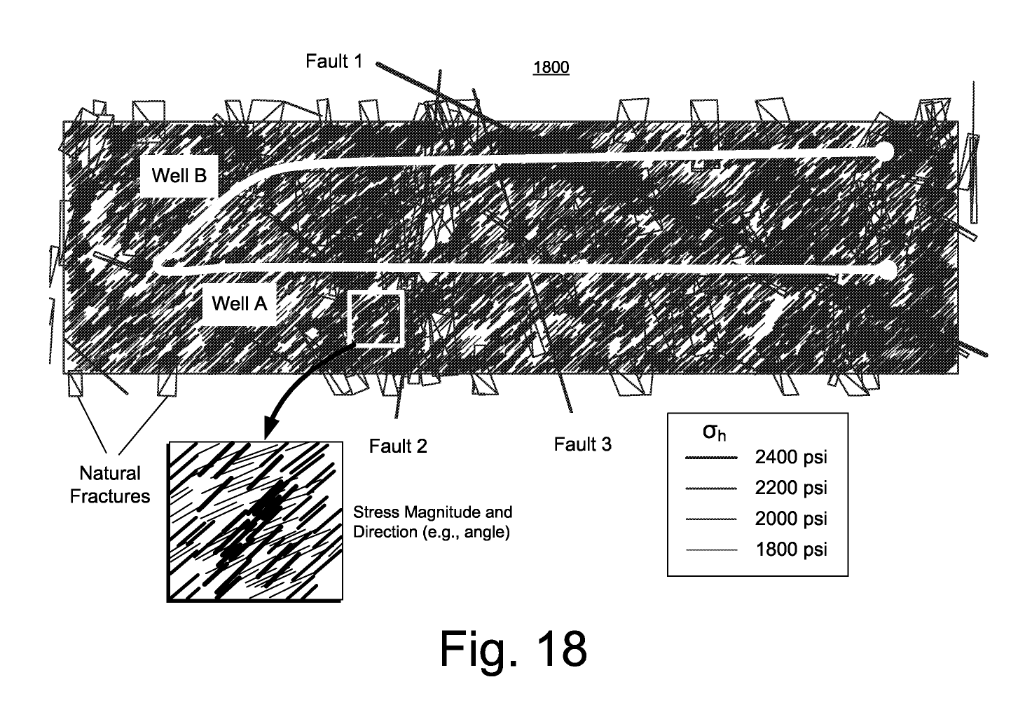

FIG. 18 shows a plan view of a model 1800 that illustrates various faults, fractures and related stress effects. An approximate scale is illustrated for stress (σₕ) magnitude values in units of pounds per square inch where magnitude is represented via different line thicknesses. In the example of FIG. 18, an enlarged portion of the model 1800 illustrates horizontal stress magnitude and direction (e.g., where magnitude as line thickness is also enlarged, ranging from about 2000 psi (thinnest lines) to about 2400 psi (thickest lines)). For example, individual cells of the model 1800 (e.g., model grid cells or elements) can include stress magnitude and direction information, which may be plotted along with other features. In the example of FIG. 18, stress information is plotted as lines where individual lines may be of a dimension larger than a cell dimension (e.g., overlap may exist for the lines). As illustrated in FIG. 18, one or more trends may exist as to stress magnitude and stress orientation (e.g., larger stress may be oriented at an angle that differs from lesser stress). Such information may be germane to one or more operations (e.g., drilling, bore stability, hydraulic fracturing, etc.). As an example, a hydraulic fracture simulator (e.g., a hydraulic fracture simulator application executable by a computing system) may receive information such as stress information illustrated in FIG. 18 (e.g., stress field information) and may simulate one or more operations, phenomena, etc. associated with hydraulic fracturing. Such a simulator may output information as to one or more stages of hydraulic fracturing that can generate desirable stimulated fracture networks in a geologic environment where a stage or stages may be specified spatially and/or temporally. For example, a plan may specify where to perform a stage and when to perform a subsequent stage; noting that in a real-time scenario, information acquired during and/or after performing a stage may be used to revise a plan (e.g., update a plan) as to one or more subsequent stages.

As an example, a model such as, for example, the model 1800 can provide information pertaining to horizontal stress rotations vertical stress tilt. As an example, a model may provide for determining various geomechanically-based attributes of a geologic environment. For example, consider one or more attributes that pertain to fracturing performance, risks, etc. As an example, a model and associated system of equations may be solved to determine, for example, initiation pressures, net pressures, fracture height (e.g., reservoir coverage and fracture containment), fracture width, near-wellbore tortuosity, stress anisotropy, etc. Such information may be mapped in a 3D space (e.g., for well placement) or along planned well trajectories (e.g., for staging/perforation placement).

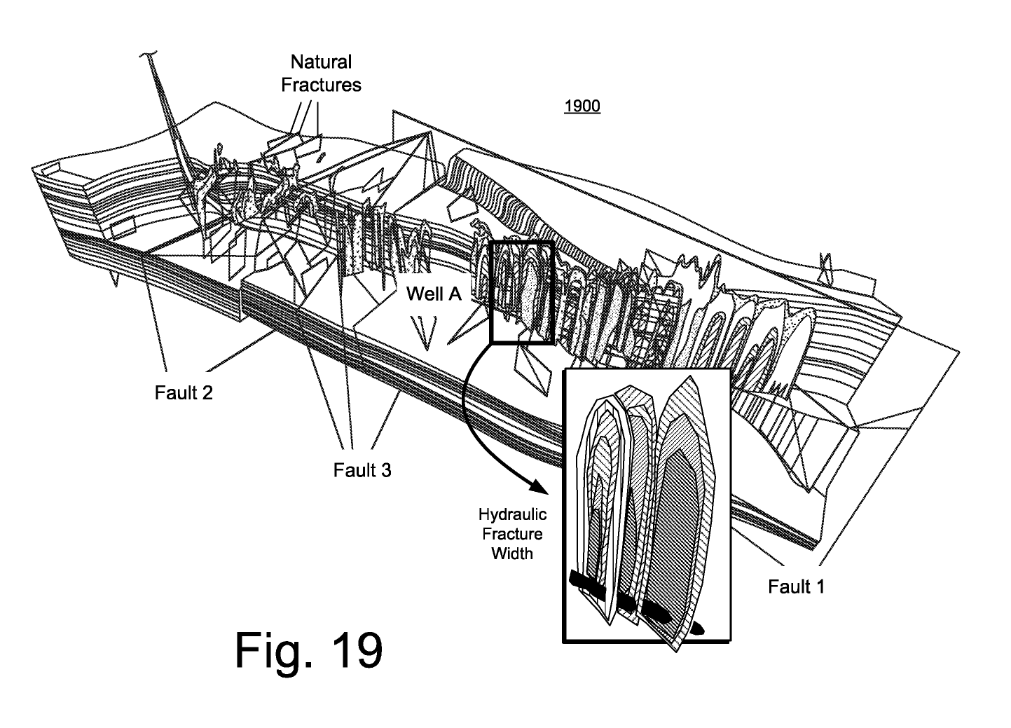

FIG. 19 shows a perspective view of an example of a model 1900 that includes hydraulic fractures. In the example of FIG. 19, the hydraulic fractures are illustrated with a scale that corresponds to a fracture dimension. For example, a hydraulic fracture may be thicker near a bore and diminish in thickness with respect to increasing distance from the bore. A model such as the model 1900 may assist with one or more of completion planning, fluid and proppant planning, staging, pumping (e.g., a pumping schedule, etc.), hydraulic fracture propped geometry planning, drainage area planning, production forecasting, etc.

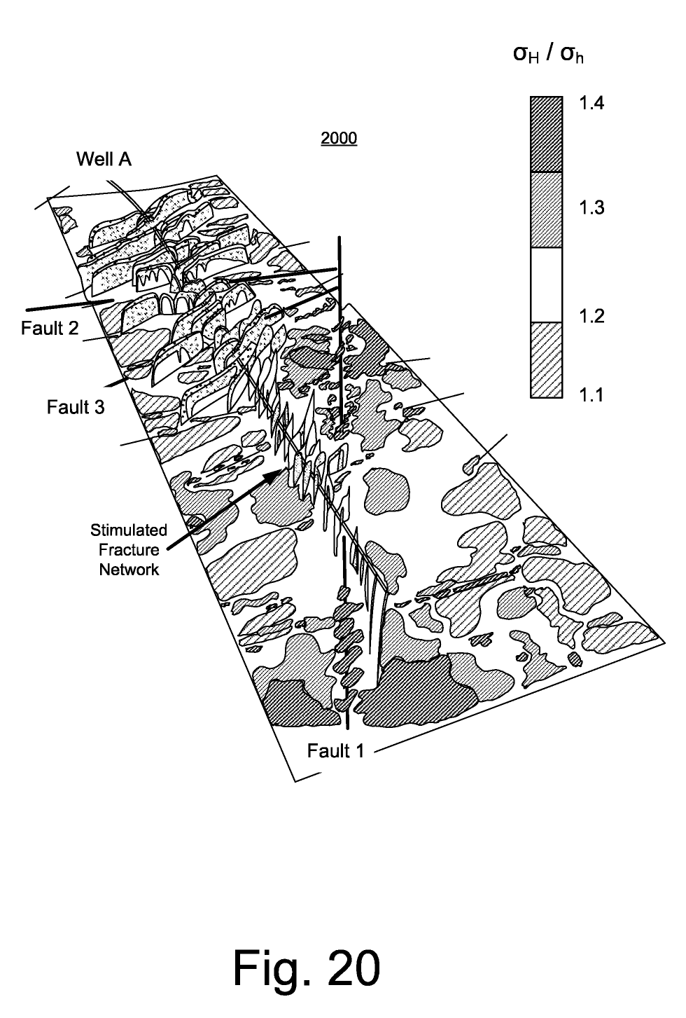

FIG. 20 shows a perspective view of an example of a model 2000 that includes hydraulic fractures. In the example of FIG. 20, the hydraulic fractures may be illustrated with a scale that corresponds to fracture width and, in a plane, a scale is illustrated in FIG. 20 with information as to stress ratio (σ_{H}/σₕ). FIG. 20 also illustrates various fracture networks. For example, consider a stimulated fracture network where a hydraulic fracture is in fluid communication with at least one natural fracture (see also, e.g., FIG. 11). In such an example, a drainage area may be enhanced such that a resource may be produced more expeditiously from a geologic environment (e.g., via drainage from one or more stimulated fracture networks to Well A).

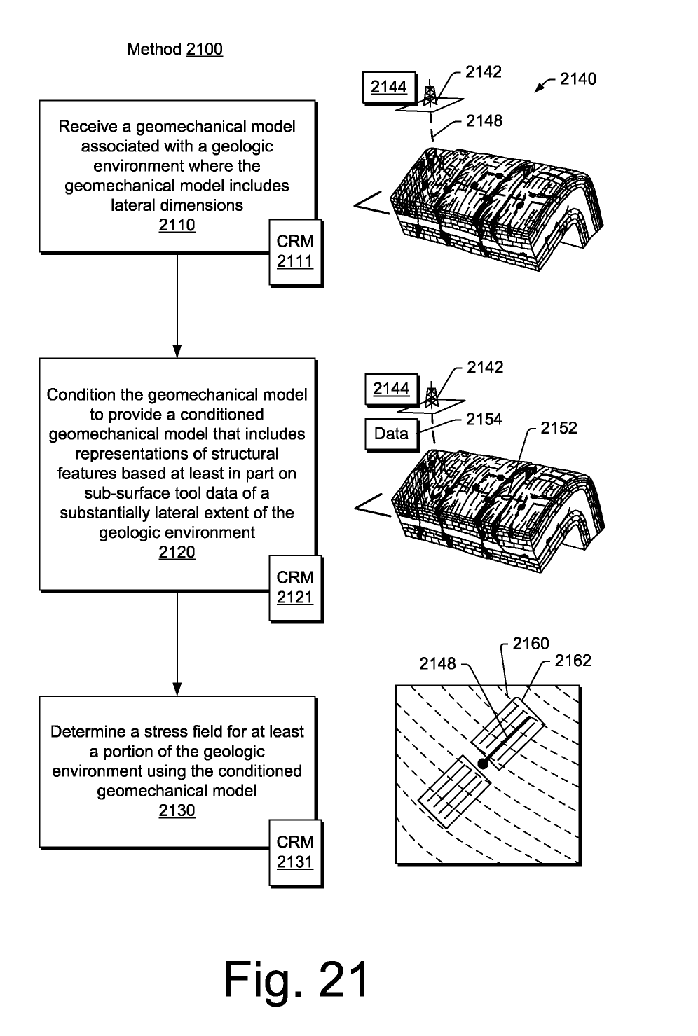

FIG. 21 illustrates an example of a method 2100 and an example of a scenario 2140. As shown, the method 2100 can include a reception block 2110 for receiving a geomechanical model associated with a geologic environment where the geomechanical model includes lateral dimensions; a condition block 2120 for conditioning the geomechanical model to provide a conditioned geomechanical model that includes representations of structural features based at least in part on sub-surface tool data of a substantially lateral extent of the geologic environment; and a determination block 2130 for determining a stress field for at least a portion of the geologic environment using the conditioned geomechanical model.

As shown in FIG. 21, the method 2100 may be associated with various computer-readable media (CRM) blocks 2111, 2121 and 2131. Such blocks generally include instructions suitable for execution by one or more processors (or cores) to instruct a computing device or system to perform one or more actions. As an example, a single medium may be configured with instructions to allow for, at least in part, performance of various actions of the method 2100. As an example, a computer-readable medium (CRM) may be a computer-readable storage medium that is non-transitory and that is not a carrier wave. As an example, blocks may be provided as one or more modules, for example, such as the one or more modules 270 of the system 250 of FIG. 2.

As to the example scenario 2140, a geologic environment may be outfitted with equipment 2142 and an associated computing system 2144 that can process information and, for example, issues instructions, commands, etc. to deploy, position, retrieve, operate, etc. equipment in a bore 2148 that includes a portion in a substantially lateral extent of the geologic environment. In such an example, a sub-surface tool 2152 may acquire data 2154 that may be processed via the computing system 2144, for example, to output stress information 2160 for at least a portion of the geologic environment. As an example, a plan 2162 for the bore 2148 may be adjusted and/or drilling of the bore 2148 may be adjusted via control of the equipment 2142. As illustrated, the plan 2162 may be a multibore plan for drilling multiple bores from a pad. As an example, a lateral portion of a bore may be oriented with respect to stress, for example, to facilitate hydraulic fracturing, to provide for bore wall integrity, etc.

As an example, a workflow may be associated with various computer-readable media (CRM) blocks. Such blocks generally include instructions suitable for execution by one or more processors (or cores) to instruct a computing device or system to perform one or more actions. As an example, a single medium may be configured with instructions to allow for, at least in part, performance of various actions of a workflow. As an example, a computer-readable medium (CRM) may be a computer-readable storage medium that is non-transitory and that is not a carrier wave. As an example, blocks may be provided as one or more modules, for example, such as the one or more modules 270 of the system 250 of FIG. 2.

As an example, a method can include receiving a finite element model associated with a geologic environment that includes a bore; revising the finite element model by embedding representations of structural features derived at least in part from data acquired via a tool positioned in the bore; and determining a stress field for at least a portion of the geologic environment using the finite element model. Such a method may include setting at least one boundary condition. As an example, a method may include, after determining a stress field, updating at least one boundary condition.

As an example, a method may include determining at least one stimulation treatment parameter based at least in part on a stress field. For example, at least one stimulation treatment parameter may correspond to a stimulation treatment associated with a bore in a geologic environment. As an example, a method may include performing the stimulation treatment, at least in part by delivering fluid to such a bore.

As an example, a method may include acquiring data via a tool positioned in a bore where the data is imagery. As an example, a method may include identifying at least one dipping plane in the imagery.

As an example, a method may include revising a finite element model by embedding representations of structural features derived at least in part from seismic data. In such an example, the seismic data may be associated with a source, a receiver or a source and a receiver disposed in a bore.

As an example, a method may include revising a finite element model to include at least one fault and/or revising a finite element model to include at least one discrete fracture network (DFN).

As an example, a geologic environment may include a bore that includes a lateral portion. As an example, a method may include performing a stimulation treatment and acquiring seismic energy data during the stimulation treatment. In such an example, a method may include updating at least one boundary condition based at least in part on seismic energy data acquired during the stimulation treatment and determining a stress field for at least a portion of the geologic environment (e.g., consider determining an update, post-treatment stress field).

As an example, a system can include a processor; memory operatively coupled to the processor; and one or more modules that include processor-executable instructions stored in the memory to instruct the system to receive a finite element model associated with a geologic environment that includes a bore; revise the finite element model by embedding representations of structural features derived at least in part from data acquired via a tool positioned in the bore; and determine a stress field for at least a portion of the geologic environment using the finite element model.

As an example, one or more computer-readable storage media can include computer-executable instructions to instruct a computer to: receive a finite element model associated with a geologic environment that includes a bore; revise the finite element model by embedding representations of structural features derived at least in part from data acquired via a tool positioned in the bore; and determine a stress field for at least a portion of the geologic environment using the finite element model.

As an example, a method can include receiving a geomechanical model associated with a geologic environment that includes a borehole where the geomechanical model includes a vertical dimension and lateral dimensions and where the borehole includes a lateral extent that spans a lateral distance in the geologic environment; conditioning the geomechanical model to provide a conditioned geomechanical model that includes representations of structural features based at least in part on borehole-wall image data of at least a portion of the lateral extent of the borehole; and determining a stress field for at least a portion of the geologic environment using the conditioned geomechanical model. In such an example, determining a stress field can include setting at least one boundary condition and such a method may include, for example, after determining the stress field, updating at least one of the at least one boundary condition.

As an example, a method can include determining at least one stimulation treatment parameter based at least in part on a stress field where, for example, the at least one stimulation treatment parameter corresponds to a stimulation treatment associated with a borehole. In such an example, the method may include performing the stimulation treatment, at least in part by delivering fluid to the borehole.

As an example, a method can include acquiring borehole-wall image data via a tool positioned in a borehole. For example, consider a sub-surface tool positioned in a lateral extent of a borehole of a geologic environment, which may include features such as fractures, faults, etc.

As an example, a method can include identifying at least one structural feature as a dipping plane. For example, a plane may intersect a borehole where evidence of the plane may exist in data acquired via a sub-surface tool (e.g., imaging tool, etc.). As an example, a method can include extrapolating the structural feature a distance away (e.g., or distances away) from the borehole where the structural feature, as extrapolated, can be represented in a geomechanical model, for example, to increase the resolution (e.g., accuracy) of the geomechanical model in one or more lateral dimensions. As an example, a method can include conditioning a geomechanical model by embedding representations of structural features based at least in part on seismic data and/or other data.

As an example, a method can include receiving a geomechanical model of a geologic environment that includes multiple boreholes and conditioning the geomechanical model by embedding representations of structural features based at least in part on borehole-wall image data of at least a portion of one or more of the boreholes.

As an example, structural features may include at least one fault. As an example, structural features may include at least one discrete fracture network (DFN).

As an example, a method can include implementing the finite element method. For example, consider a method that includes receiving geomechanical model that is or includes a finite element model associated with a numerical solver that implements the finite element method.

As an example, a method can include performing a stimulation treatment that is based at least in part on a stress field determined via a conditioned geomechanical model and, for example, acquiring seismic energy data during the stimulation treatment. In such an example, the method may include updating at least one boundary condition of the conditioned geomechanical model based at least in part on the seismic energy data acquired during the stimulation treatment and determining an updated stress field for at least a portion of the geologic environment.

As an example, a system can include a processor; memory operatively coupled to the processor; and one or more modules that include processor-executable instructions stored in the memory to instruct the system to receive a geomechanical model associated with a geologic environment that includes a borehole where the geomechanical model includes a vertical dimension and lateral dimensions and where the borehole includes a lateral extent that spans a lateral distance in the geologic environment; condition the geomechanical model to provide a conditioned geomechanical model that includes representations of structural features that are based at least in part on borehole-wall image data of at least a portion of the lateral extent of the borehole; and determine a stress field for at least a portion of the geologic environment using the finite element model. In such an example, the geomechanical model may be or include a finite element model. As an example, a system can include processor-executable instructions stored in memory to instruct the system to implement a numerical solver that applies the finite element method.

As an example, one or more non-transitory computer-readable storage media can include computer-executable instructions to instruct a computer to: receive a geomechanical model associated with a geologic environment that includes a borehole where the geomechanical model includes a vertical dimension and lateral dimensions and where the borehole includes a lateral extent that spans a lateral distance in the geologic environment; condition the geomechanical model to provide a conditioned geomechanical model that includes representations of structural features that are based at least in part on borehole-wall image data of at least a portion of the lateral extent of the borehole; and determine a stress field for at least a portion of the geologic environment using the finite element model. In such an example, the geomechanical model can be a finite element model and, for example, the instructions can include instructions to implement a numerical solver that applies the finite element method.

As an example, a method can include receiving a geomechanical model associated with a geologic environment where the geomechanical model includes lateral dimensions; conditioning the geomechanical model to provide a conditioned geomechanical model that includes representations of structural features based at least in part on sub-surface tool data of a substantially lateral extent of the geologic environment; and determining a stress field for at least a portion of the geologic environment using the conditioned geomechanical model. In such an example, the sub-surface tool data may be or include image data.

As an example, a method can include analyzing at least a portion of sub-surface tool data to identify a location of a fault and extrapolating the fault away from the location. In such an example, the extrapolating can include extrapolating the fault at least in part laterally away from a representation of a bore in a geomechanical model.

As an example, a method can include acquiring sub-surface tool data via a sub-surface tool disposed in a bore where, for example, the bore is a borehole or a well. As an example, a method can include acquiring additional sub-surface tool data and determining a stress field for at least a portion of a geologic environment based at least in part on at least a portion of the additional sub-surface tool data.

As an example, a method can include acquiring sub-surface tool data while drilling substantially laterally in a geologic environment and, for example, adjusting the drilling based at least in part on a determined stress field (e.g., determined using a conditioned geomechanical model, etc.).

As an example, a system can include a processor; memory operatively coupled to the processor; and one or more modules that include processor-executable instructions stored in the memory to instruct the system to receive a geomechanical model associated with a geologic environment where the geomechanical model includes lateral dimensions; condition the geomechanical model to provide a conditioned geomechanical model that includes representations of structural features based at least in part on sub-surface tool data of a substantially lateral extent of the geologic environment; and determine a stress field for at least a portion of the geologic environment using the conditioned geomechanical model. In such an example, the system can include an interface that receives the sub-surface tool data while drilling substantially laterally in the geologic environment and, for example, the system may include instructions to generate information to adjust drilling based at least in part on a determined stress field where, for example, the interface can transmit at least a portion of the information (e.g., to a controller, etc. associated with drilling equipment).

As an example, one or more non-transitory computer-readable storage media can include processor-executable instructions to instruct a computing system to: receive a geomechanical model associated with a geologic environment where the geomechanical model includes lateral dimensions; condition the geomechanical model to provide a conditioned geomechanical model that includes representations of structural features based at least in part on sub-surface tool data of a substantially lateral extent of the geologic environment; and determine a stress field for at least a portion of the geologic environment using the conditioned geomechanical model. In such an example, processor-executable instructions may be included to instruct a computing system to generate information to adjust a drilling operation based at least in part on the stress field.

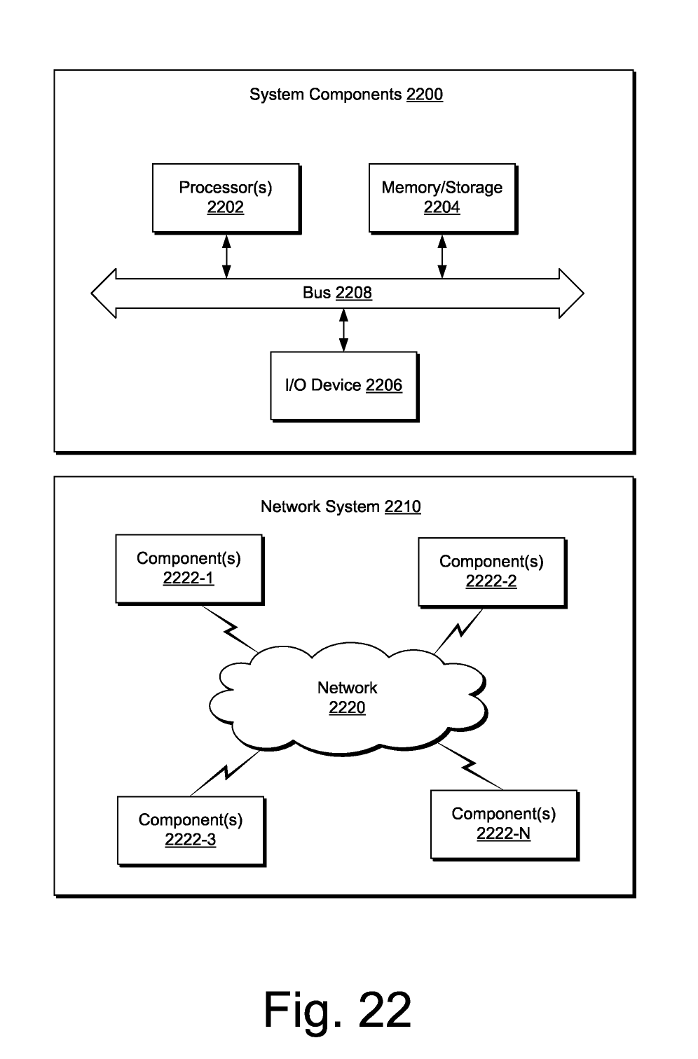

FIG. 22 shows components of an example of a computing system 2200 and an example of a networked system 2210. The system 2200 includes one or more processors 2202, memory and/or storage components 2204, one or more input and/or output devices 2206 and a bus 2208. In an example embodiment, instructions may be stored in one or more computer-readable media (e.g., memory/storage components 2204). Such instructions may be read by one or more processors (e.g., the processor(s) 2202) via a communication bus (e.g., the bus 2208), which may be wired or wireless. The one or more processors may execute such instructions to implement (wholly or in part) one or more attributes (e.g., as part of a method). A user may view output from and interact with a process via an I/O device (e.g., the device 2206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2210. The network system 2210 includes components 2222-1, 2222-2, 2222-3, . . . 2222-N. For example, the components 2222-1 may include the processor(s) 2202 while the component(s) 2222-3 may include memory accessible by the processor(s) 2202. Further, the component(s) 2202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH™, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method (1200) comprising:
receiving a geomechanical model associated with a geologic environment that comprises a borehole wherein the geomechanical model comprises a vertical dimension and lateral dimensions and wherein the borehole comprises a lateral extent that spans a lateral distance in the geologic environment (1210);
conditioning the geomechanical model to provide a conditioned geomechanical model that comprises representations of structural features based at least in part on borehole-wall image data of at least a portion of the lateral extent of the borehole (1220); and
determining a stress field for at least a portion of the geologic environment using the conditioned geomechanical model (1230).

2. The method of claim 1 wherein the determining a stress field comprises setting at least one boundary condition.

3. The method of claim 2 further comprising, after determining the stress field, updating at least one of the at least one boundary condition.

4. The method of claim 1 further comprising determining at least one stimulation treatment parameter based at least in part on the stress field.

5. The method of claim 4 wherein the at least one stimulation treatment parameter corresponds to a stimulation treatment associated with the borehole.

6. The method of claim 5 further comprising performing the stimulation treatment, at least in part by delivering fluid to the borehole.

7. The method of claim 1 further comprising acquiring the borehole-wall image data via a tool positioned in the borehole.

8. The method of claim 1 further comprising identifying at least one of the structural features as a dipping plane.

9. The method of claim 1 further comprising conditioning the geomechanical model by embedding representations of structural features based at least in part on seismic data.

10. The method of claim 1 wherein the geologic environment comprises an additional borehole and wherein the conditioning the geomechanical model comprises embedding representations of structural features based at least in part on borehole-wall image data of at least a portion of the additional borehole.

11. The method of claim 1 wherein the structural features comprise at least one fault.

12. The method of claim 1 wherein the structural features comprise at least one discrete fracture network (DFN).

13. The method of claim 1 wherein the geomechanical model comprises a finite element model associated with a numerical solver that implements the finite element method.

14. The method of claim 1 further comprising performing a stimulation treatment that is based at least in part on the stress field and acquiring seismic energy data during the stimulation treatment.

15. The method of claim 14 further comprising updating at least one boundary condition of the conditioned geomechanical model based at least in part on the seismic energy data acquired during the stimulation treatment and determining an updated stress field for at least a portion of the geologic environment.

16. A system (250) comprising:
a processor (256);
memory (258) operatively coupled to the processor; and
one or more modules (270) that comprise processor-executable instructions stored in the memory to instruct the system to
receive a geomechanical model associated with a geologic environment that comprises a borehole wherein the geomechanical model comprises a vertical dimension and lateral dimensions and wherein the borehole comprises a lateral extent that spans a lateral distance in the geologic environment (1211);
condition the geomechanical model to provide a conditioned geomechanical model that comprises representations of structural features that are based at least in part on borehole-wall image data of at least a portion of the lateral extent of the borehole (1221); and
determine a stress field for at least a portion of the geologic environment using the finite element model (1231).

17. The system of claim 16 wherein the geomechanical model comprises a finite element model.

18. The system of claim 17 wherein the one or more modules comprise processor-executable instructions stored in the memory to instruct the system to implement a numerical solver that applies the finite element method.

19. One or more non-transitory computer-readable storage media comprising computer-executable instructions to instruct a computer to:
receive a geomechanical model associated with a geologic environment that comprises a borehole wherein the geomechanical model comprises a vertical dimension and lateral dimensions and wherein the borehole comprises a lateral extent that spans a lateral distance in the geologic environment (1211);
condition the geomechanical model to provide a conditioned geomechanical model that comprises representations of structural features that are based at least in part on borehole-wall image data of at least a portion of the lateral extent of the borehole (1221); and
determine a stress field for at least a portion of the geologic environment using the finite element model (1231).

20. The one or more non-transitory computer-readable storage media of claim 19 wherein the geomechanical model comprises a finite element model and wherein the instructions comprise instructions to implement a numerical solver that applies the finite element method.

21. A method (2100) comprising:
receiving a geomechanical model associated with a geologic environment wherein the geomechanical model comprises lateral dimensions (2110);
conditioning the geomechanical model to provide a conditioned geomechanical model that comprises representations of structural features based at least in part on sub-surface tool data of a substantially lateral extent of the geologic environment (2120); and
determining a stress field for at least a portion of the geologic environment using the conditioned geomechanical model (2130).

22. The method of claim 21 wherein the sub-surface tool data comprises image data.

23. The method of claim 21 comprising analyzing at least a portion of the sub-surface tool data to identify a location of a fault and extrapolating the fault away from the location.

24. The method of claim 23 wherein the extrapolating comprises extrapolating the fault laterally away from a representation of a bore in the geomechanical model.

25. The method of claim 21 wherein the geologic environment comprises a bore and wherein the sub-surface tool data comprises data acquired via a sub-surface tool disposed in the bore.

26. The method of claim 25 wherein the bore comprises at least one member of a group consisting of a borehole and a well.

27. The method of claim 21 further comprising acquiring additional sub-surface tool data and determining a stress field for at least a portion of the geologic environment based at least in part on at least a portion of the additional sub-surface tool data.

28. The method of claim 21 further comprising acquiring the sub-surface tool data while drilling substantially laterally in the geologic environment.

29. The method of claim 28 further comprising adjusting the drilling based at least in part on the stress field.

30. A system (250) comprising:
a processor (256);
memory (258) operatively coupled to the processor; and
one or more modules (270) that comprise processor-executable instructions stored in the memory to instruct the system to
receive a geomechanical model associated with a geologic environment wherein the geomechanical model comprises lateral dimensions (2111);
condition the geomechanical model to provide a conditioned geomechanical model that comprises representations of structural features based at least in part on sub-surface tool data of a substantially lateral extent of the geologic environment (2121); and
determine a stress field for at least a portion of the geologic environment using the conditioned geomechanical model (2131).

31. The system of claim 30 further comprising an interface that receives the sub-surface tool data while drilling substantially laterally in the geologic environment.

32. The system of claim 31 wherein the instructions comprise instructions to generate information to adjust the drilling based at least in part on the stress field and wherein the interface transmits at least a portion of the information.

33. One or more non-transitory computer-readable storage media comprising processor-executable instructions to instruct a computing system to:
receive a geomechanical model associated with a geologic environment wherein the geomechanical model comprises lateral dimensions (2111);
condition the geomechanical model to provide a conditioned geomechanical model that comprises representations of structural features based at least in part on sub-surface tool data of a substantially lateral extent of the geologic environment (2121); and
determine a stress field for at least a portion of the geologic environment using the conditioned geomechanical model (2131).

34. The one or more non-transitory computer-readable storage media of claim 33 comprising processor-executable instructions to instruct a computing system to generate information to adjust a drilling operation based at least in part on the stress field.
